(19) United States
(12) Patent Application Publication
(10) Pub. No.: US 2014/0180706 A1
(43) Pub. Date: Jun. 26, 2014

(54) HUMAN SERVICES STRATEGIES OUTCOME GENERATOR

(71) Applicant: James HANLEY, Johnstown, PA (US)

(72) Inventor: James HANLEY, Johnstown, PA (US)

(21) Appl. No.: 14/107,422

(22) Filed: Dec. 16, 2013

Related U.S. Application Data
(60) Provisional application No. 61/738,642, filed on Dec. 18, 2012.

(51) Int. Cl. G06Q 10/06; G06F 19/00

(52) U.S. Cl. CPC G06Q 10/0637; G06F 19/3431
USPC 705/2; 705/7.36

(57) ABSTRACT

A human services strategies outcomes generator. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### BACKGROUND

1. Technical Field

This present application relates to a Human Services Strategies Outcome Generator, and more specifically toward computer software for human services professionals. This application relates to a software program with various applications for human services professionals, and human service delivery systems. Specifically the applications related to conducting a systematic approach that will allow data to be collected and analyzed to produce more effective decision making processes and better outcomes through the professional assessments of interventions applied to mitigate and reduce dysfunctional behaviors and activities of clients involved in human services and collecting the aggregate data and analyzing data to determine the amount of change in client behavior and activities and the impact the invention is having on clients as well as the aggregate impact inventions are having in different fields of human services delivery systems.

2. Background Information

Background information is for informational purposes only and does not necessarily admit that subsequently mentioned information and publications are prior art. The Human Services Strategies Outcomes Generator (“outcomes generator”) has been designed to provide a method and process for human services workers who provide human services interventions to individuals, adults, children and families to empirically measure the successful change those clients make in response to the intervention applied. An intervention is any activity in which a human services worker provides to a client as a means of improving that client's situation, life circumstances or individual condition. Human services workers are defined as any person/persons engaged in or responsible for providing a service to an individual (adult or youth), or a family, in a setting that provides an opportunity for that client to learn a positive method that can change their situation, life circumstance or individual condition. The outcomes generator scores the impact of the intervention being applied and tracks changes over the time period from when the intervention begins to when it concludes. The outcomes generator provides human services workers the ability to score observable measures that relate to each intervention applied and score how well the client responds to the intervention. The outcomes generator further provides the human services workers the ability to do this in interval time periods in order to track the progress of change and/or success associated with each client's response to the intervention.

Within any particular human service delivery systems, the ability to accurately and consistently measure service provided to clients, human services professionals have relied on their own training and background to report how well a client is responding to an intervention. That response has typically been categorized as “good”, “fair”, or “poor” with antidotal examples of their assessment.

This approach to assessment of client response to and impact from the intervention did not provide the necessary data to assist in planning for the most effective intervention to a client's presenting problems. The ability of human service systems, at the State level, County level and Service Provider level, to produce quality intervention services and provide accurate and meaningful assessments both for individual clients as well as shaping the entire service delivery system's approach to providing treatment for identified problems has been less than successful in mitigating these problems. The has led to a cycle of ineffective treatment and interventions that do not meliorate the problems and prolongs treatment, costing the systems more than necessary.

In the past, approaches to mitigating identified problems within a human service delivery system did not allow human services professionals a method to systematically collect data that could be evaluated empirically or objectively to determine its effectiveness.

In the past the State level agencies who have responsibilities for oversight of human service delivery systems have not had a method by which to accurately collect and analyze data to determine (1) the effectiveness of interventions applied to resolving identified problems within their particular service delivery system, (2) the impact interventions have on clients and how clients respond to the interventions applied, and (3) the impact in the cost effectiveness of interventions being applied in the particular human service delivery system.

In the past, County level agencies who have the responsibility for assuring services are available to populations within their particular geographical area (i.e. a “County”) have been unable to define empirically how effective those services are in resolving the identified problems within a particular service delivery system. County level agencies have relied on antidotal information that have provided little empirical data to determine the effectiveness of inventions applied. County level agencies have not had a method by which to accurately collect and analyze data to determine (1) the effectiveness of interventions applied to resolving identified problems within their particular service delivery system, (2) the impact interventions have on clients and how clients respond to the interventions applied, and (3) the impact in the cost effectiveness of interventions being applied in the particular human service delivery system. County level agencies and professionals have relied on obtaining antidotal information to Service Provider level agencies that have provided documentation as a requirement of the contract provisions and not as a method and process to measuring effectiveness of interventions or for future planning of the service delivery system itself.

In the past Service Provider level agencies have had the responsibility of contracting with county level agencies to provide direct service interventions to identified clients. The service provider level agencies have not had any uniformed method for demonstrating through empirical data the results of their encounters with clients or the clients response to interventions applied and the impact intervention have had in making a positive change to the client. Service provider level agencies and professionals have relied on providing antidotal information to County level agencies and have provided documentation as a requirement of the contract provisions and not as a method and process to measuring effectiveness of interventions or for future planning of the service delivery system itself.

Finally, human service professionals continue to show poor outcomes for the service interventions being applied throughout human service delivery systems and the costs for these interventions continues to rise in every State. Currently, human service delivery systems have no reliable or valid methodology in which the systematically collect and analyze data that is collected in a reliable and valid process across the entire delivery system. The computer software program in this patent disclosure provides a new method and way for human service professionals to (1) collect empirical data, (2) have consistent definitions of outcomes and outcome indicators, (3) apply scoring to observable measures based on a standardized scoring definition and standard to provides for reliable and valid data collection, (4) the ability of Service Provider level agencies to use a method and methodology for consistent assessment of client responses to interventions, (5) the ability of County level agencies to collect and analyze the effectiveness of interventions, the impact interventions have in changing identified problems within there geographical boundaries, (6) ability of the State level agencies to collect and analyze empirical data collected in a systematic, reliable and valid method and methodology of interventions applied in different human service delivery systems for the entire state geographical area and utilize the data to determine the impact and cost analysis of tax dollars for the applied interventions within the human service delivery systems.

### OBJECT OR OBJECTS

An object of at least one possible embodiment of the present application is to provide a method and process to allow human services agencies to collect, analyze and report the impact of services provided to families, children and individuals involved in a human services delivery system. Accordingly, this software program with applications has many advantages over past program and applications and they are:
(a) software has been designed to be easy to administer and easily understood for all service delivery systems. The software provides State agencies to create: (1) Observable measures for data collection, (2) Defined standards for each area of assessment to be used by all providers, (3) Defined scoring system to assure consistent application by all data collectors and (4) a powerful set of tools to create outcomes at the direct service level, at the supervisory level, at the administrative level, at the State level;
(b) provides the necessary structure to assure reliability and validity of the model when used while allowing service providers the professional subjectivity that allows them to do their job well;
(c) within the human service delivery systems, there is essentially no other process/method that provides the accuracy and comprehensiveness;
(d) as a web-based portal, will allow all service providers within their respective fields of service access to the State defined data collection processes and methods and will provide a fully comprehensive and collaborative effort to evaluate the impact services are having with consumers;
(e) will allow the State systems to fully understand: (1) the families strengths and challenges to be addressed, (2) the service providers impact of services that will be working to assist the family, (3) how well the services provided are allowing the family to make positive changes to correct their identified problems, and (4) conduct cost/benefit analysis to utilized existing funds to their fullest potential;
(f) human service professionals will be able to makes available to each service provider the opportunity to assess intervention and services and users will be able to retrieve real time data about how a family is progressing;
(g) allows the creation of direct, secure and electronic linkages between software program and human service professionals, State, County and Service Provider level agencies within a human service delivery system for electronic transmission of pertinent data in a timely and secure fashion;
(h) can be used by all kinds of human services professionals;
(i) will provide statistical analysis and allow human services professionals to empirically evaluate clients and systems changes and impacts from interventions applied;
(j) provides the forum for multiple services provided across multiple service systems and human service categories to evaluate each family members progress while collecting comprehensive data to evaluate the entire delivery approach for success; and
(k) provides opportunities for all the information to be contained in one place, rather than scattered across multiple agencies or individuals and provides the ability to access complete real time information.

### SUMMARY

The Human Services Strategies Outcome Generator is software that provides a method and process to allow human services agencies to collect, analyze and report the impact of services provided to families, children and individuals involved in a human services delivery system.

The software is for government, community and private human services agencies that provide oversight, referral and/or services and interventions to collect, analyze and report specifically defined data measures to determine the outcomes and impact those service have had in changing the condition, lives or situation of families, children and individuals (clients of service and interventions). The software provides a method and process by which: (1) outcome areas are defined, (2) associated outcome indicators are defined with a standard for assessment, (3) data measurements are defined in observable measures, and (4) a scoring scale is defined for users. The process allows for the collection, analysis and reporting of data collected for each outcome area and as aggregate outcomes of data collected in various human service delivery systems.

The outcome generator takes the outcome indicator scores and aggregates or collects or combines the data in order to calculate an average baseline score of all outcome indicators for each particular outcome area and develop an average baseline score as it relates to each indicator and to the outcome area. The process by which this happens is to take all baseline scores as a percentage and divide the sum total of scores by the number of assessments completed. This process also occurs for each month an outcome indicator is scored and provides the means in which to generate a report that shows the success rate of each outcome area using the baseline scores as a measure by which to see the change or success that has occurred.

The following summation provides detailed descriptions of the operations of the outcome generator, the step by step process by which scores are calculated, and how the percentage scores are determined. The calculation methods do not calculate any weighted measures and are determined based on the scoring provided and the total points allowable.

The outcome generator is designed to provide empirical measurement, as a percentage score, of observable measures as used in human services by professional staff in the application of interventions to resolve identified client issues. The outcome generator is designed to allow agencies to develop the observable measures to be scored, to allow for observable measures to be placed into categories that define outcome indicators and outcome indicators to be used to assess overall outcome areas. The outcome generator is designed to allow for outcome areas to be defined via the creation of outcome indicators and for outcome indicators to be defined by both a standard and a defined scoring scale for human service staff to apply when scoring observable measures.

The design of the outcomes generator is as follows:

Outcome Area—Overall area to be measured for success in a field of human services.

An “outcome area” is a broad statement that allows a human services delivery system to define a distinct issue that is to be addressed through human services delivered and has clearly defined indicators and observable measures that are used to measure successful achievement. For example:
Outcome Area: Child/Children safety in the child welfare delivery system
Outcome Area: Appropriate medication for patients with mental health disorder in the mental health delivery system
Outcome Area: Self determination for individuals with a functional disability in the mental retardation system

Outcome Indicator—Used to further define the outcome area and the factors that comprise an outcome area. There can be multiple outcome indicators for each outcome area. An “outcome indicator” is a clearly defined statement that allows human services delivery systems to specify how an outcome area will be measured. There can be more than one indicator for an outcome area. For example: Outcome Indicator: Each child will have suitable and sustainable shelter that meets his/her needs.
Outcome Indicator: Patients with a diagnosis related to mood disorders will receive the proper medication and dosage.
Outcome Indicator: Parents of functional disabled children will choose the level of care their child will receive.

Outcome Indicator Standard (Standard)—Used to define the standard of activity that is ideal to the outcome indicator. The standard provides the basis in which the human service staff measures the client's response to intervention being applied to meet the desired outcome for the outcome indicator and outcome area. For example:
Outcome Indicator
   Standard: Each Child will live in a dwelling that has working utilities and is free of hazards on a daily basis.

Observable Measure—Used to define what is to be measured for the outcome indicator. The observable measure is defined by activities that (1) relate to the outcome indicator standard and (2) can be observed as part of the intervention being applied to the client. Examples of observable measures (OM):
OM1: Parent(s)/caretaker(s) pays water bill each month.
OM2: Parent(s)/caretaker(s) pays electric bill each month.
OM3: Parent(s)/caretaker(s) pays heating bill each month.
OM4: Parent(s)/caretaker(s) is not is arrears of paying utility bills.
OM5: Parent(s)/caretaker(s) adequately cleans the home.
OM6: Parent(s)/caretaker(s) pays mortgage/rent as agreed upon.
OM7: Parent(s)/caretaker(s) has maintained adequate housing for 12 months.

Scoring Scale—the scoring scale is a scale of defined scored from one (1) to five (5) that is used to describe the client's response to interventions that relate to the outcome indicator and outcome area. The scoring level indicates the client's ability to measure up to the standard defined for each outcome indicator. The higher the score given, the more successful the client is in meeting the standard for each outcome indicator. Observable measures are scored 1 to 5 based on the standard/scoring definition every 30 days.

The components of the outcome generator are as follows:

Outcome Area Development Form—provides for the capacity to label and define the outcome area that is to be measured.

Outcome Indicator & Standard Development Form—provides for the capacity to label and define the outcome indicators and associated standards as they relate to the outcome area.

Observable Measures Form—provides for the capacity to label and define observable measures that relate to each outcome indicator and standard for each outcome area.

Data Input Sheet—provides the capacity to enter the client's demographic information (last name, first name, middle name/initial, date of birth/age, social security number, medical insurance identification number, gender, religion, ethnicity, street address, etc. The sheet provides the human service worker the capacity to review the outcome area, outcome indicators and standards, the scoring scale and the observable measures for each client's intervention and to score the success of each client. The sheet also provides the capacity to collect data related to number of interventions/visits of the human service worker that have been scheduled, that have been kept and that have been cancelled, the total duration in hours and minutes of the intervention applied to the client, the type of intervention applied, and the name of the agency and individual or team applying the intervention.

Monthly Summary Sheet—provides the capacity to collect each outcome area's outcome indicator's observable measure scores and arrange them into a table that summarizes the scoring completed by the human service worker. The sheet provides for a delineation of baseline scoring and subsequent month scoring for each outcome area's outcome indicator and provides all scoring in a percentage basis for each outcome indicator scored. The sheet provides a composite client success score that defines the client's overall success response to a particular outcome area and outcome indicator.

Monthly Client Success Graph—a visual depiction of the percentage scoring for each outcome area and outcome indicator, which provides the baseline assessment as well as the current month assessment and the previous month assessment for the client. The graph provides the legend key indicating what each percentage score relates to in terms of success of the client. The legend key is designed to indicate success (green), limited success and cautionary level for further intervention (yellow), and very little or no success and critical level for further intervention (red). Each level of success has a range of percentage scores that have been developed to coincide with the scoring system for each observable measure and thereby provides the following success scale by which client's response to intervention is measured:

| | | |
|---|---|---|
| 0% to 39% | Red Level | Critical Level - evidence of little or no |
| | | success by the client in the outcome |
| | | area and further intense intervention is |
| | | warranted or to continue with client |
| 40% to 59% | Yellow Level | Cautionary Level - evidence of limited |
| | | success by the client in the outcome |
| | | area and further intervention is |
| | | warranted or is to be continued with the |
| | | client |
| 60% to 100% | Green Level | Success Level - evidence of adequate |
| | | success by the client in the outcome |
| | | area and further intervention is no |
| | | longer warranted or is to be continued |
| | | with the client. |

Impact Form—provides the capacity for the measurement of funding impact based on the intervention applied and the client's response to that intervention as measured by the outcome generator in the applied outcome areas and outcome indicators. Using the composite client success score of the client and the number of visits scheduled/kept and the total intervention hours applied, the outcome generator then calculates an impact score, which is a percentage score that indicates how much of the funding utilized for the intervention can be applied directly to the intervention, thus determining how the funding of an intervention has impacted the change made by the client. The calculation for determining impact is: Composite Client Success Score, divided by the sum of appointments scheduled, divided by appointments kept, and multiplied by the total funds utilized for the intervention.

The process is as follows:

1) After a 30 days period human services staff use the observable measures within each outcome indicator and apply a score of 1 to 5 to each observable measure. The score is based on the human services staff expertise as well as applying the outcome indicator standard and the scoring definition to the observable measure. The procedure takes place for all applicable observable measures being utilized to assess the client.

2) The scoring for each outcome indicator is totaled and divided by the total available score and calculates the scoring into a percentage score. The percentage score represents the client's level of success in reaching the standard within the outcome indicator.

3) Each outcome indicator area is scored in the same manner until the human services staff has completed all outcome indicators assigned to the client.

4) The scores for each outcome area are then placed into a summary table; they are added together and divided by the number of outcome indicator areas scored to calculate the composite client success score.

5) The initial assessment completed provides for the client's baseline scores in each outcome indicator area. This baseline scoring is used to measure the level of success the client experiences every 30 days when the assessment is completed again. The change in percentage scores indicates the change in success the client is having with the human services intervention being applied.

6) The outcome generator also collects data related to the number of visits that are scheduled, kept and cancelled. Additionally the total number of hours utilized for the intervention(s) for the 30 day period is also collected.

The above-discussed embodiments of the present invention will be described further herein below. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

This application pertains to an embodiment of a computer software program that provides a method, methodology, process and practice to allow different agencies to accurately and consistently measure the impact human service interventions are having on clients and provide a data collection and analysis method to allow for aggregate level determinations of human service delivery systems outcome measurements. The computer software programs provides fast and secure access to relevant and relative applications within the fields of (a) children, youth and families, (b) mental health and behavioral health, (c) addiction and other drugs, (d) mental retardation and intellectual disabilities, (d) early childhood education and learning, (e) early intervention services, (f) aging services, (g) educational services and any other human service field that requires measurement of outcome measures. The computer software provides functions that allow for the collection of data of interventions applied to clients participating in services from a human services provider agency (State, County and/or Service Provider) and can be applied in fields of human services that provide oversight for, and direct intervention of services to benefit clients with an identified need within a human service delivery systems. The computer software program can be applied humans services that involve multi-cultural issues, medication monitoring, psychopharmacology, insurance companies, professional ethics, note taking, contracts, insurance billing, legal statutes, current and past research, profession-setting applications, statistical analyses, university setting applications, educational setting applications, human services knowledge, client tracking, business process tracking, financial tracking, time tracking, intervention tracking, databases, database management, tele-medicine, tele-psychiatry, and/or any other sort of undertaking associated with providing a human services intervention such as counseling-oriented services, psychological services, behavioral modification services, direct care services such as housekeeping, home management, assistance with activities of daily living, mentoring services, child care assistance, daycare services, business-oriented services, clerical services, employee evaluation services, clerical, habilitative and rehabilitative services, and/or record keeping services, and other services that exists or has yet to be discovered. The computer program will have direct, secure and electronic linkages and access through existing and/or yet to be discovered electronic, Internet, and web-based connections to various human services professionals, entities, businesses, organizations, institutions of higher learning, communication mediums that exist or have yet been discovered, billing agencies, insurance companies, monetary and credit transactions, internet sites and/or businesses, publishers, databases, journals, research, legal statutes, ethics codes and/or any kind of information that exist or has yet been discovered with conducting activities in any human service fields. This computer software program will provide the means for professional efficiency in all realms of interventions, therapies, counseling, education, mentorship, direct care services, psychology, psychiatry, medicine, behavioral health, business, professional and para-professional human services duties, responsibilities and work and/or any other professional and/or para-professional activity associated with any human services fields.

### BRIEF DESCRIPTION OF THE DRAWINGS

The present application is explained in greater detail below with reference to the accompanying drawings, in which:

FIG. 1 shows an Outcome Area;

FIG. 2 shows an Outcome Indicator/Standard of Measurement;

FIG. 3 shows a Scoring Scale;

FIG. 4 shows a Monthly Summary Report;

FIG. 5 shows a Monthly Summary Graph;

FIG. 6 shows Individual Scoring Areas for Each Individual and Family Being Scored;

FIG. 7 shows Items That Must Be Checked When Formatting Graph;

FIG. 7A shows an Overall Assessment of Outcome Indicator;

FIG. 8 shows a Monthly Summary Sheet;

FIG. 9 shows an Overall Client Success Score Box;

FIG. 9A shows a Composite Client Success Score;

FIG. 10 shows a Graph for a Baseline Assessment;

FIG. 11 shows human services professionals data collection and evaluation of client response to interventions applied using the computer program software using templates and/or designs as well as the direct electronic linkages and delivery of said data collection and assessment and graphic depiction of results to State human service agencies, County Human service agencies, Service Provider service agencies, Educational institutions, Insurance companies and any other business that exist and/or has yet been discovered;

FIGS. 12A and 12B show the ability of the development of outcome areas, outcome indicators associated to each Outcome area, associated indicator standards to the outcome indicators, and the observable measures that are associated with each outcome indicator;

FIG. 13 shows the flow of work activities performed at the State Agency level, County Agency level and Service Provider level;

FIG. 14 shows how the user of the computer software program applies the defined scoring measures when performing interventions applied and its applications and the algorithm that converts the raw scores into a percentage score using the computer software program via direct, secure and electronic linkages with various human services agencies, businesses, organizations and entities that exists or has yet been discovered;

FIG. 15 shows how the computer software program and its applications can provide statistical analyses on relevant activities, information and data collected by human service professionals;

FIG. 16 shows how users of the computer software program and its applications can access databases and research relevant and related to human service delivery systems;

FIG. 17A, FIG. 17B, FIG. 17C, and FIG. 17D show how a user of the computer software program and its applications can access various kinds of information and data related to a human services delivery system;

FIG. 18 shows how human services professionals can create portable files containing client assessment information and data and send it electronically to various professional businesses, organizations and/or institutions;

FIG. 19 shows the utilization of internet and technological devices to transmit data and information;

FIG. 19A shows how service provider data and scoring goes to main database and how data gets transmitted to county and state databases;

FIG. 20 shows a process of collecting, analyzing and displaying scoring completed by service provider;

FIG. 21 shows secure log in screen of outcome generator;

FIG. 22 shows state agency landing page;

FIG. 22B shows the State Agency Outcome Area Development & Outcome Indicator Development Page;

FIG. 22C shows how to add or edit outcome area, outcome indicator and indicator standard;

FIG. 23 shows State's page for creating Observable measures for outcome area/indicators/standards;

FIG. 23B shows how observable measures can be added or edited or changed;

FIG. 24 shows the landing page for county agencies;

FIG. 25A shows the County Agency add/editing client demographic information and concern and insurance information;

FIG. 25B shows how to add client concern and intervention;

FIG. 25C further shows how to add client concern and intervention;

FIG. 26A shows county page showing assignment of assessment tool to client;

FIG. 26B shows ability of county agency to Add assessment to a client;

FIG. 27 shows county agency ability to chose service provider to make referral for services/client;

FIG. 28A schematically shows a portion of a process flow of steps taken in at least one embodiment of the present disclosure;

FIG. 28B schematically shows a further portion of the process flow of steps taken in at least one embodiment of the present disclosure; and

FIG. 28C schematically shows yet a further portion of the process flow of steps taken in at least one embodiment of the present disclosure.

### DESCRIPTION OF EMBODIMENT OR EMBODIMENTS

At least one possible embodiment of the present application provides software that allows for human service staff to collect, analyze, and report data on the impact services have in changing the lives, situation, or condition of families, children and individuals involved in the human service delivery system. At least one possible embodiment of the present application provides a method to allow observable data to be collected and then scored on a scale of 1 to 5, based on a standard established as well as professional judgment, which is then translated into an empirical score, as a percentage, that demonstrates the client's current level of response to the applied services and/or intervention by the service provider. The software provides for a baseline measurement to be established for each client as an individual and/or as a unit (such as a family) and ongoing assessments. The software, method and process provides human service staff data collection to be displayed as a graph that indicates the client's response to services and intervention and collects data to provide aggregate outcome measures to measure the impact the services and interventions are achieving with clients. The graph uses a bar graph, or graphs combined with a line graph, or graphs and uses the colors green, yellow and red to indicate the level of success for each indicator measured. The solid color bar represents baseline assessment score. The lined-colored bar is nestled inside the baseline bar and represents the previous month assessment. A line graph with colored markers indicates the current month scoring. The bars for a previous month, and the markers for the current month, show the percentage score for each indicator scored.

In at least one possible embodiment of the present application, human services workers use observable measurements to score on a scale of 1 to 5, based on a defined scoring definition and standard that is applied to each outcome indicator and outcome area. The software allows for outcome areas, outcome indicators and standards to be defined by the user. The scoring is completed every 30 days, according to at least one possible embodiment of the present application. The scores generate a percentage of functioning that indicates the level of change the individual or family is having at that particular time of assessment. The software collects all data measurements and computes a percentage score that ranks change based on an original baseline score and then aggregates the data to give a composite score for the entire family or individual. The first assessment serves as the baseline assessment by which all other assessments will be compared. The software provides access to report writing templates to provide qualitative data to complement the quantitative data collected and provides the end user a visual depiction in graph form of the family, child, individual's current level of change. The software also collects aggregate data to allow for macro-analysis of the entire service delivery system.

Logging onto a secure website, the user would enter a password and username to gain access, in at least one possible embodiment of the present application. The user would then select the appropriate outcome areas and corresponding assessments. The user would observe a family, child, or individual over a 30-day period and would apply the scoring standards to each observable measurement utilized on the assessment. In other possible embodiments, the user would observe a family, child, or individual for a period of time other than 30 days. The user would complete each appropriate assessment and would provide a written report to correspond with the data collected.

The software collects and stores demographic information of clients to be used to allow for various outcomes to be generated based on demographic information collected and provides identifying information for agencies to apply the correct measurements to the right clients.

At least one possible embodiment of the present application improves the collection, analysis and dissemination of data collected in the field of human services as it relates to the impact services have on changing family, child, and/or individual situations.

Another possible embodiment of the present application provides a method and process for collecting, analyzing and disseminating data that is collected to measure impact on another individual, system or event to allow for a visual depiction of the impact. Examples include an educational system to measure impact educational processes have on children, and the impact marketing had on customer expansion and retention.

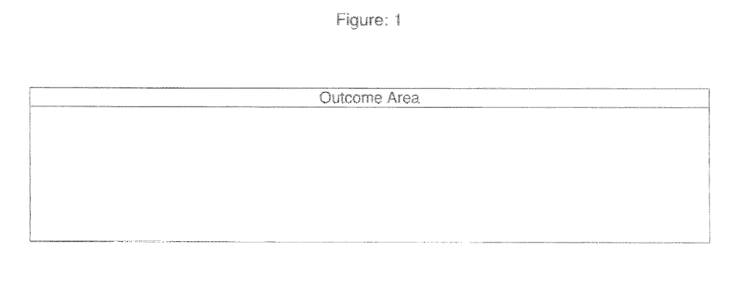

FIG. 1 shows an Outcome Area. This is the overarching area in which outcome indicators, standards and observable data measures will be defined by the user to demonstrate the impact of intervention/service on a family, child, or individual clients.

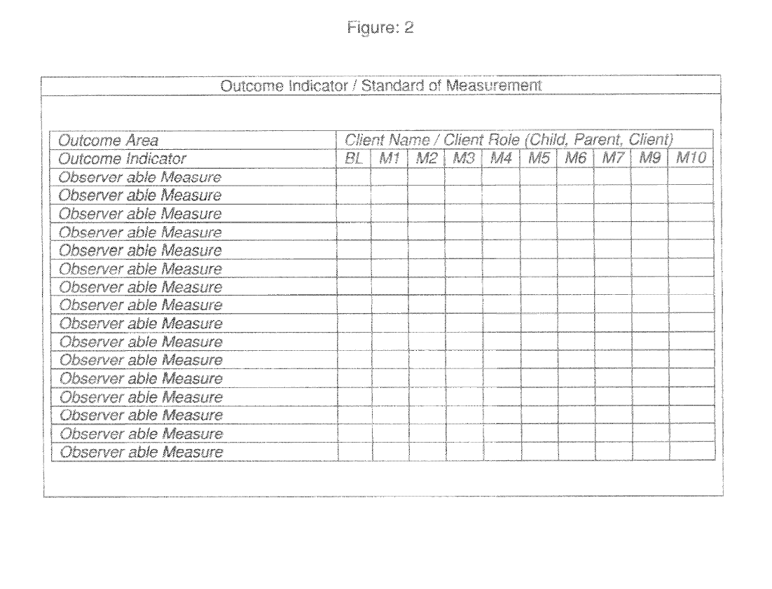

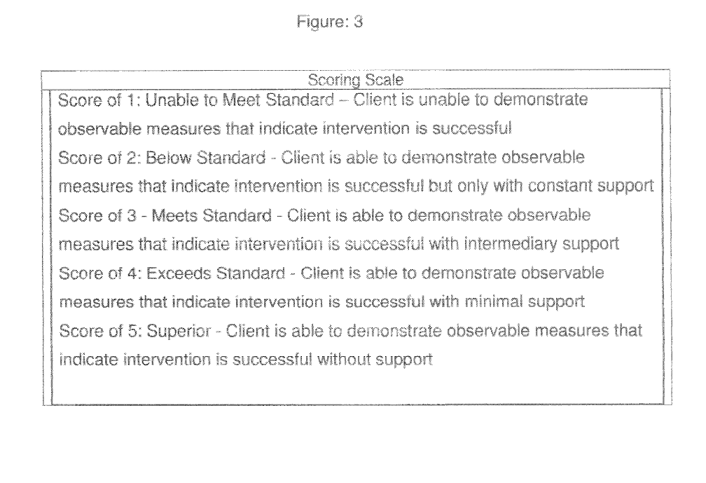

FIG. 2 shows an Outcome Indicator/Standard of Measurement. The Outcome Indicator/Standard of Measurement will be defined so that the end user can apply their scoring of observable measures based on this standard. The standard developed will provide the structure which determines and justifies the score given to each observable measure.

FIG. 3 shows a Scoring Scale. As shown, a Score of 1 is “Unable to Meet Standard”. This Score indicates that a Client is unable to demonstrate observable measures that indicate intervention is successful. A Score of 2 is “Below Standard,” which indicates that a Client is able to demonstrate observable measures that indicate intervention is successful but only with constant support. A Score of 3 is “Meets Standard,” which indicates that a Client is able to demonstrate observable measures that indicate intervention is successful with intermediary support. A Score of 4 is “Exceeds Standard.” This Score indicates that a Client is able to demonstrate observable measures that indicate intervention is successful with minimal support. A Score of 5 is “Superior.” A Score of 5 indicates that a Client is able to demonstrate observable measures that indicate intervention is successful without support.

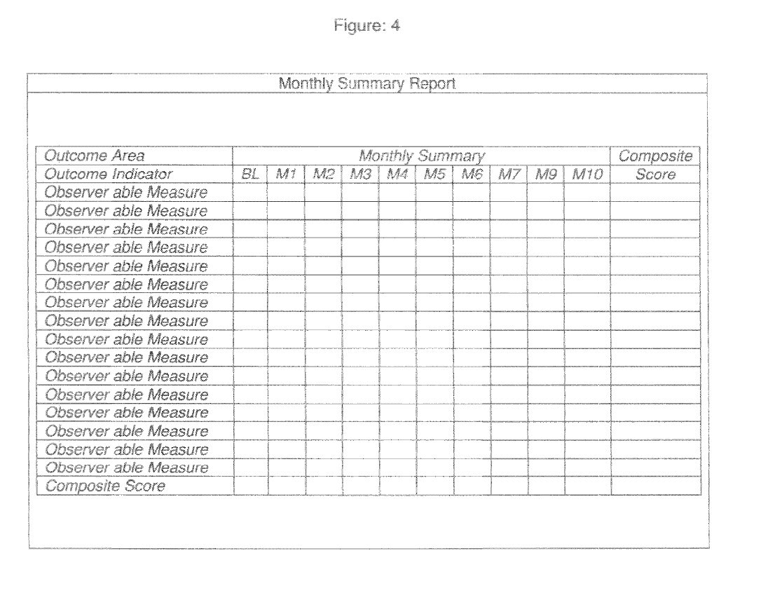

FIG. 4 shows a Monthly Summary Report. This Report provides the end user with a method and process and template to provide qualitative data collected during the reporting period that is used to generate the empirical scoring data completed by the end user.

The Monthly Summary Report Headings/Categories include:
1. Intervention techniques utilized for the reporting period;
2. Based on observation explain client's response to interventions attempted;
3. Identify the current strengths and challenges and caution areas experienced by the client;
4. Identify client behaviors that provide justification for empirical data collection for the reporting period; and
5. Identify the next steps and interventions involved with the client for the next reporting period.

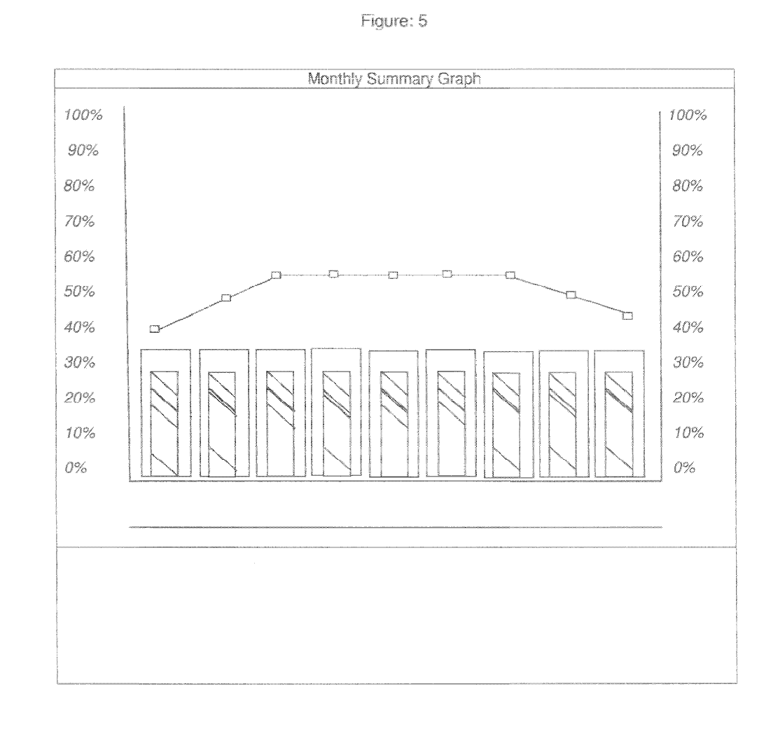

FIG. 5 shows a Monthly Summary Graph. This Graph provides a visual depiction of the end user's assessment of observable measures and comprises a baseline assessment (initial assessment), the previous month's assessment and current month's assessment of the impact of services for the client. FIG. 5 is a representation of at least one possible embodiment of a Monthly Summary Graph. An actual graph depiction would be based on actual scoring of measurable data. Also, Outcome Indicators would be listed under each bar.

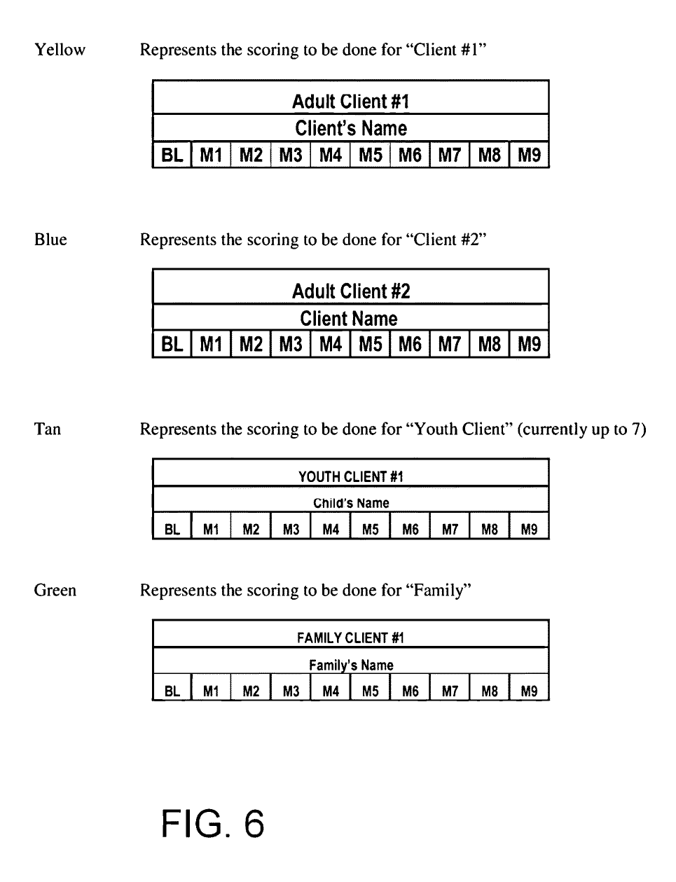

FIG. 6 shows the individual scoring areas for each individual and family being scored. In at least one possible embodiment, the columns are arranged and color-coded as indicated.

### Technical Specifications of the Outcomes Generator

There are tabs located at the bottom of the Excel spreadsheet. Usually there are only three tabs that need to be reviewed in order to update the graph format:

### (1) Data Input Sheet

The sheet is designed with outcome areas, outcome indicators and standards that are related to observable measures that define the human services intervention being applied to the client.

This is where the therapist enters in (a) the Family Name, (b) the number of assessments being completed, (c) the number of people being assessed (Baseline only), and (d) their scoring for the assessments for the month.

### (2) Monthly Summary Sheet

This is where the monthly assessment surveys are summarized individually and where the information for the graphical representation (the graph) for the monthly assessment is pulled from.

This is also where the cumulative percentage for the month is calculated, as well as where the therapist is able to track the progression of progress for each family throughout the months of service.

### (3) Client Success Graph

This is the graph that gets developed based on the scores by the therapist each month. The graph is a depiction of the family's Baseline Score (which remains constant throughout services), and the most recent two months of service.

The graph also provides a month-by-month summary of the family's cumulative (composite) scores.

Within each of these 3 tabs (or sheets) there will need to be changes made to assure that the graph that is printed out is accurate and correct. The steps are outlined below in a sequential order—IT IS IMPORTANT TO FOLLOW THE SEQUENCE OF STEPS FOR EACH GRAPH.

Note: The tabs (or spreadsheets) located between the data input tab and the monthly summary sheet are the sheets used to calculate each of the outcome indicator via observable measure scoring as such the surveys that are completed for the client. The client can be an individual or could be a family unit as a whole or both. These tabs will rarely need to be touched when completing the formatting of graphs each month. On occasion, when the number of people being assessed for a particular outcome indicator changes from one month to another, the individual tab associated with the outcome indicator should be entered and the “Overall Assessment” calculations should be changed to assure accuracy of the scoring for that particular month.

### Data Input Sheet

This sheet serves to allow scores to be entered for individual adult clients and individual child/youth clients and for families as a whole unit, based on who is being assessed for the month. The layout of this page contains the following items for the user to enter:

### (1) Client Last Name

Enter the client's last name(s). This should be the same as the official name used to open the client into services.

### (2) # Months of Service

Enter in the current number of assessments being completed.

Note: Baseline assessments are listed as “Baseline”, NOT “1”. Month 1 assessment is “1”. Also when a client is being discharged, DO NOT type in “Discharge” in this space. The current number of assessments should be entered into this space.

### (3) Outcome Indicator

On the right hand side—Each outcome indicator is listed with “Number of Adult Client(s) Being Assessed” or “Number of Youth Clients Being Assessed”. Family assessments do require a number to be entered. The proper, or appropriate, number of people being assessed in each of the outcome indicators must be entered. This number is entered when the Baseline Assessment is complete and should never change. If there is a change in the number of people being assessed, then the number being assessed in the “Overall Assessment” area must be manually changed in each individual assessment tab.

### (4) Individual Scoring Areas

The columns to the right of the Outcome Indicator listings represent the individual scoring areas for each individual and family being scored. In at least one possible embodiment of the present application, the columns are arranged and color-coded:
Yellow Represents the scoring to be done for “Client #1”;
Blue Represents the scoring to be done for “Client #2”;
Tan Represents the scoring to be done for “Youth Client” (currently up to 7); and
Green Represents the scoring to be done for “Family”.

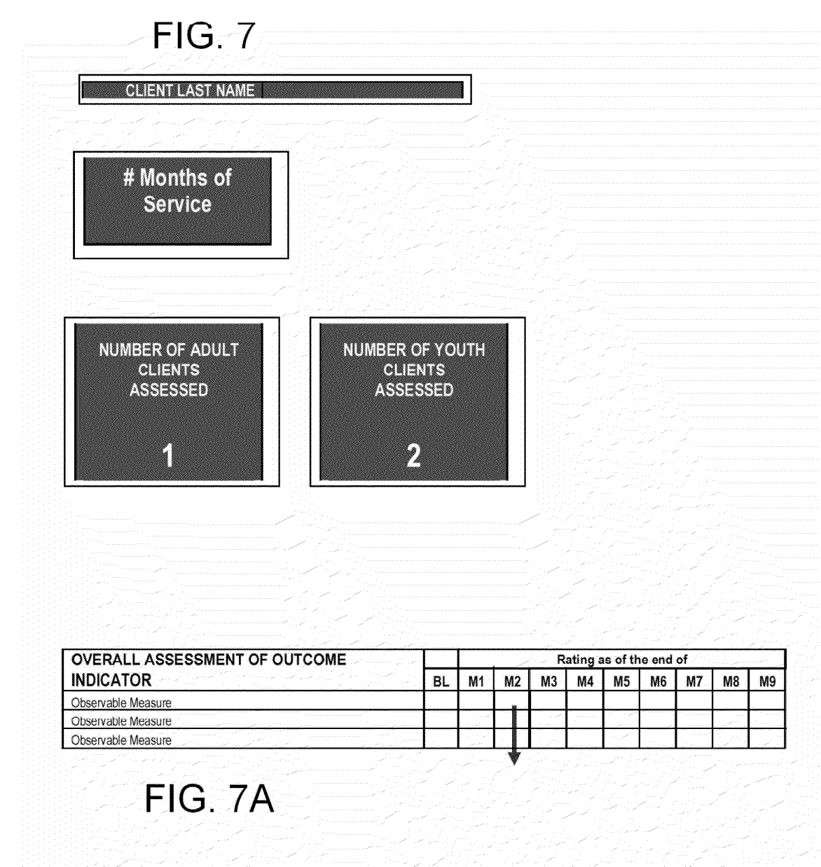

FIG. 7 shows items that must be checked when formatting graph:

(1) Make sure the Client Last Name is listed correctly;
(2) Make sure the “#Months of Service” is correct; and
(3) Make sure the “Number of Adult Clients and/or Youth Clients” number is correct for each of the corresponding assessment areas.

IF THE NUMBER OF INDIVIDUALS BEING ASSESSED DOES NOT MATCH UP WITH THE NUMBER LISTED UNDER EACH OUTCOME INDICATOR THEN:

### (1) Baseline Month

Change the number to the right one under the outcome indicator. This is the only time this change will be made.

### (2) Month 1 & Subsequent Month Assessments

For the outcome indicator that has changed—go to the corresponding individual tab at the bottom of the spread sheet and click on that tab. Within that tab, scroll to the bottom until the “Overall Assessment” is reached, then go to the corresponding month. FIG. 7A shows an Overall Assessment of Outcome Indicator.

Action to be Taken:

### Step 1

Click on cell that corresponds with the first data element. While on this cell, press “F2”. The user will see the formula used to create the value of this cell (E.G.=+(D13+D28)/‘DATA INPUT SHEET’!$A$14). Manually change “DATA INPUT SHEET’!$A$14” to the current month number being assessed [Adult Client 1 or 2/Youth Client is number being assessed in the current month].

### Step 2

Highlight the cell the user just changed and copy it down the entire column for the current month. The number that goes into this cell is created by the formula (=+(D13+D28)/‘DATA INPUT SHEET’!$A$14). Each cell has a corresponding formula that automatic transfers the number enter from the Data Input Sheet and calculates from the “Number being Assessed” from the Data Input Sheet to give the corresponding value for the Overall Assessment for any given month. This step must be completed for each Outcome Indicator in which the number of Adult Client/Youth Client is being assessed has changed from the Baseline Assessment.

Summary of Steps needed to complete each month:
1. Verify Client Name is Correct.
2. Verify the Months of Service is Correct.
3. Verify the number of individuals (adult client and/or youth client) being assessed is correct.
4. Verify that the last outcome indicator is complete for the current month.

Note: Remember—if the number of individuals being assessed has changed from the previous month to the current month, the user must follow the above steps to manually change the number being assessed in the corresponding individual survey tab. DO NOT CHANGE THE NUMBER BEING ASSESSED ON THE DATA INPUT SHEET.

Once this is completed—Move to the Monthly Summary Sheet.

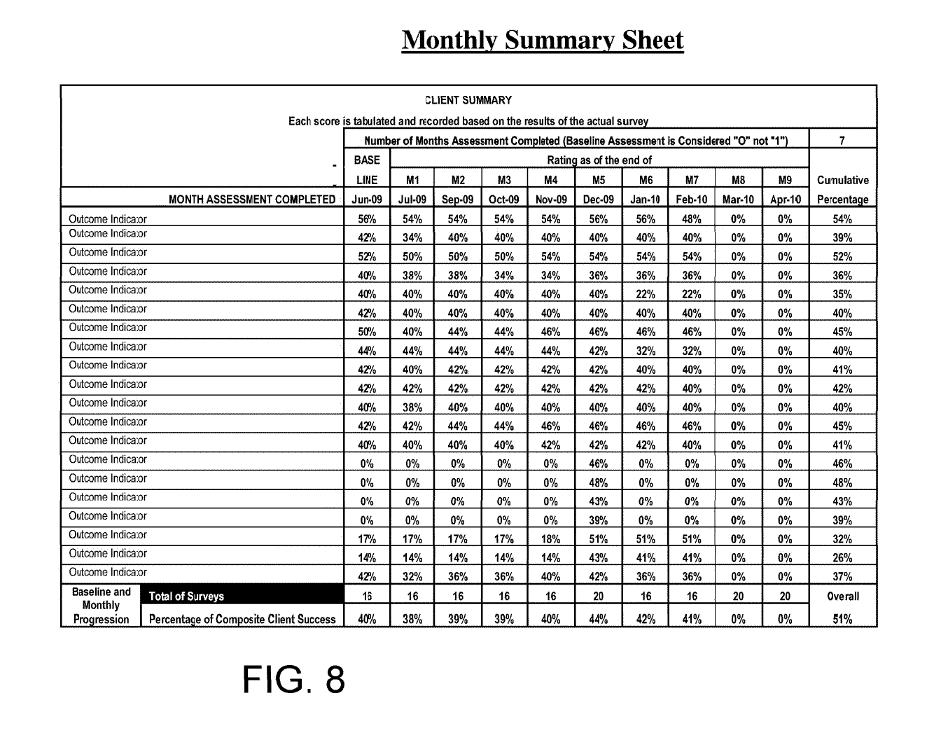

FIG. 8 shows a Monthly Summary Sheet. This sheet shows the scores for the individual outcome indicators for each particular month and provides an overall composite score for the client. This sheet shows the scores for the individual outcome indicators for each particular month and provides an overall composite score for the client. These numbers are pulled from the Data Input Sheet and the individual tabs for the surveys. Also pulled from the Data Input Sheet is the Number of Months Assessments Completed. THERE IS NO REASON TO EVER MANUALLY CHANGE ANY % SCORE ON THIS SHEET.

1) Review this sheet for the current month to verify that all numbers for the outcome indicators completed look to be correct. Usually if there is a problem, the current month's scores will be either extremely high or extremely low compared to the previous month's scores—if this is the case click back to the Data Input Sheet and check the Number Being Assessed box on the right side of the sheet (located under each outcome indictor heading) and compare that number to the actual number of individuals assessed (just look in the current month and follow the column down). If everything looks ok proceed onto the Client Progress Graph tab.

2) Check the “Total Surveys” to verify the number equals the number of surveys completed. If it needs to be changed, change it manually. Enter in the current Month in the cell next to “Month Assessment Completed” and then fill in the subsequent months for assessments #1 through #9.

816 Once this is completed—Move to the Client Progress Graph tab Client Progress Graph.

The graph is the visual representation of the scoring completed. The information that is used to develop the graph comes from the Monthly Summary Sheet (that pulls its information from the Data Input Sheet and Individual Outcome Indicator tabs). This requires the most manual manipulations and will cause the user to “jump” back to the Monthly Summary Sheet. There are basically 4 different types of formatting that must be completed to create the graph, depending on the client's current status of services:

Baseline Graphs;

Month 1 Graphs;

Month 2 Graphs; and

All Subsequent Month Graphs.

Baseline Assessment—Formatting the Graph

(1) Type in Client Last Name (Caps/font: between 24 to 26/Bold);
(2) Type in “BASELINE ASSESSMENT” in cell next to Client Last name. (Caps/font: between 24 to 26/Bold); and
(3) Scroll down to the “Overall Client Success Score” box.

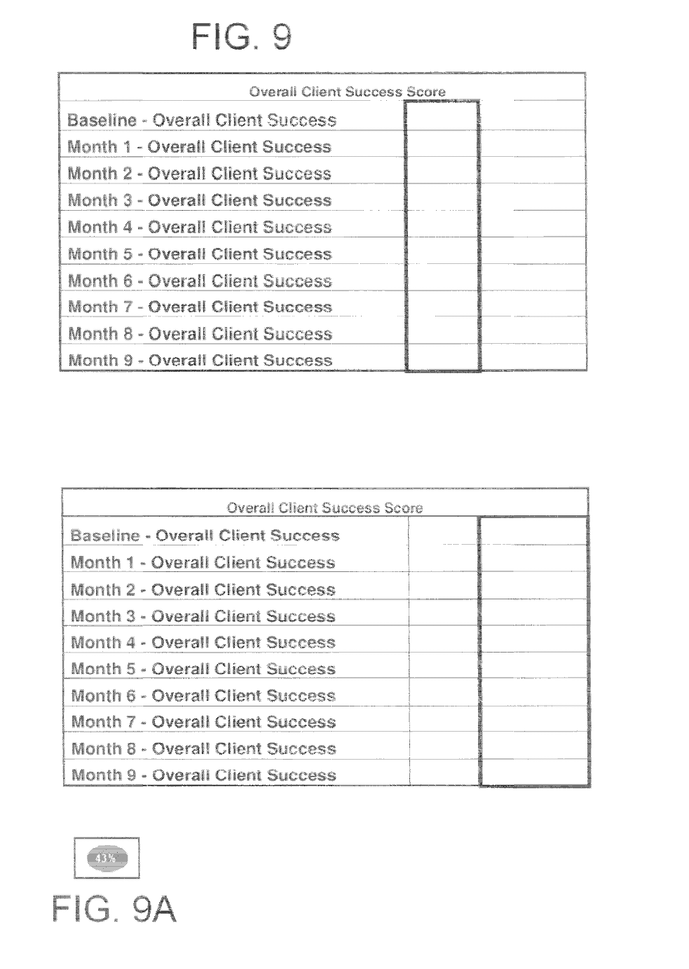

FIG. 9 shows an Overall Client Success Score box.

(4) Scroll up so the graph itself can be fully seen on the screen. Find the small blue circle with a white percentage in it, as shown in FIG. 9A. (This box is the Composite Client Success Score that was entered in the step above.) To format this follow these steps:
1) Right Click on Circle→select Edit Text;
2) Right click→Format Cell;
3) Move to the front of the number and type in the Family Composite Number with the “% sign”;
4) Delete any text behind the “%”; and
5) Center & Bold and size to fit over the closest proximity on the axis of the graph.
   (5) Now right click on the graph itself—these following steps will make the graph the correct color and have the correct percentages in the correct position.

After right click on graph→click on “Source Data”;

→Click on “Series” tab at the top of box;

→Highlight/Delete “Name” field→type in “BASELINE”;

→Click on the small box to the right of the “Values” field;

→The user should see the Monthly Summary Sheet come up with the Baseline column highlighted. Make sure the highlighted boxes for the ALL outcome indicators scored are highlighted and then click on the small box to the right of the field & return to the Source Data box. (If the “Name” field has reverted back to its original state, follow Step (3) again).

Click on the small box to the right of the “Category (X) axis label” field→Should see the Monthly Summary Sheet again→make sure the highlighted area is around the outcome indicators scored. Click on the small box to the right of the field & return to the Source Data box.

Click ok.

Click back to the Monthly Summary Sheet→Highlight the Baseline column→click to color the cells gray and the numbers red. Down to “Percentage of Composite Functionality”.

Click back to the Client Progress Graph tab.

To format the % scores for each bar on the graph→Right click on the numbers→“Format Data Labels” →“Font” →Bold→under “color” click on the drop-down to the right and select the blue square [top row, 6th square in]→under “size” select 10.→Go to “Alignment” tab→under “Label Position” click drop-down menu and select “Outside End” →click ok.

To color the bars for each assessment score the following color guide is used:

Red—Any score 39% or below 39%;

Yellow—Any score between 40% and 59%; and

Green—Any score of 60% or above.

To highlight the bars, the user must put the cursor over the bar and (1) to change the color of all bars at the same time→right click or (2) to change color of a single bar→right click/left click.

Once the user have highlighted a bar (or all bars)→Right click→Format Data Point→“Patterns” select the appropriate color of all bars at the same time→right click or (2) to change color of a single bar→right click/left click.

Once the user has highlighted a bar (or all bars)→Right click→Format Data Point→“Patterns” select the appropriate color based on the % score (red, yellow of green)→“Options” Assure the “Gap width” field is set at 20. The proper color on the “Patterns” field is as follows:

Red—located in the middle of the first column;

Yellow—located 3rd column 4th one down; and

Green—located 4th column 4th one down (next to yellow).

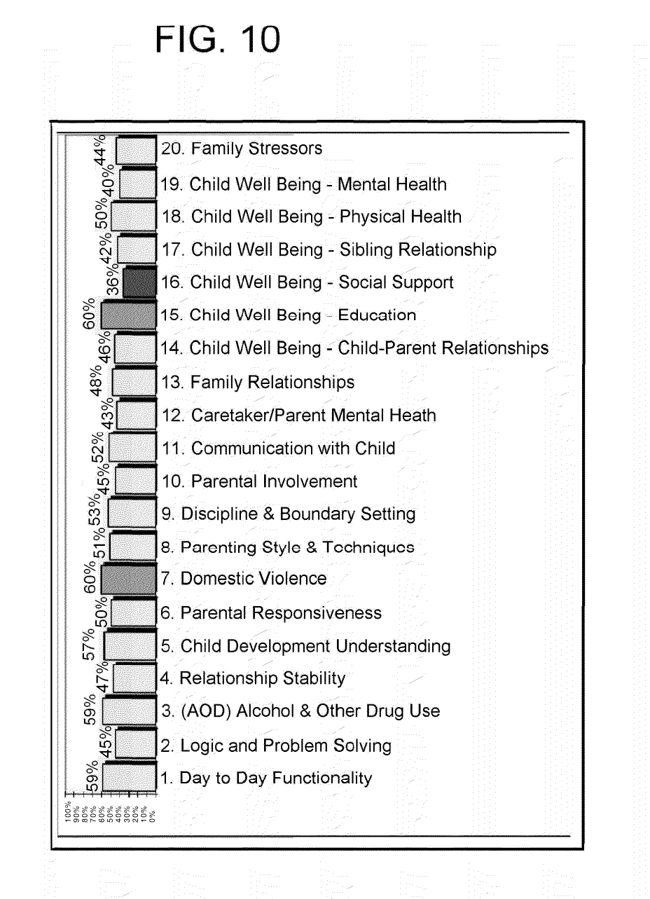

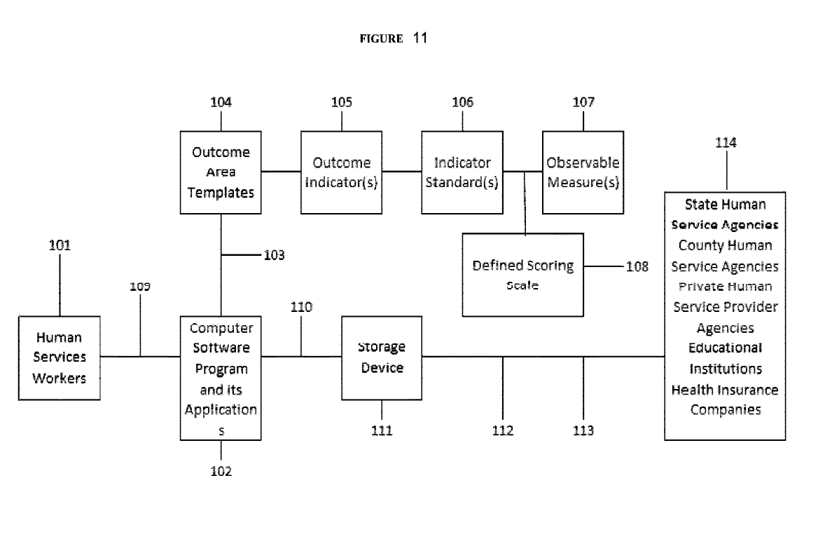

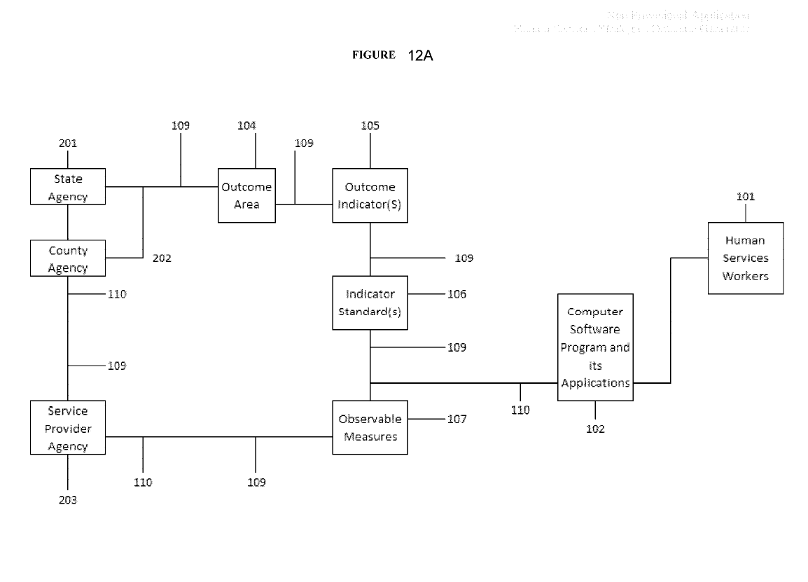

Once the user has followed these steps, the graph should look like the graph shown in FIG. 10. (Note: Coloring of bars is correct in this graph). THIS GRAPH FOR A BASELINE ASSESSMENT IS NOW COMPLETE.

This process is followed for all graphing, which will include the baseline graph and the most current month of scoring for a client and the previous month of scoring for a client. The following process provides the steps to do every time regardless of what type of graph is being formatted:

(1) Check the Data Input sheet to assure that:
(a) Client Last Name is listed;
(b) # Months of Service is correct; and
(c) the Number of Adult Clients and Youth Clients being assessed is correct with actual surveys completed.
   (2) Check Monthly Summary Sheet to assure that:
(a) Month Assessment Completed is correct; and
(b) Total outcome indicators is correct.

### Baseline Graph Formatting

1. Graph Heading: [Font Size between 24-36/Bold]
(a) Type on right side last name of Client/Click Align Text Right button; and
(b) Type “BASELINE ASSESSMENT”/Click Align Text left button.

### 2. Bottom of Graph:

(a) “Overall Composite Client Success Score” box;
   (i) format far right column for “Mth-yy”/enter Current month assessed completed; and
   (ii) enter in the % score from the Monthly Summary Sheet (BL Column).

### 3. Graph

(a) Make sure the Family Composite Score on the far left “circle” is correct;
(b) Format the % score for each bar showing in each outcome indicator; and
(c) Color each bar for each outcome indictor the appropriate color (red, yellow, or green).

### Month 1 Graph Formatting

1. Graph Heading: [Font Size between 24-36/Bold]
(a) Type on right side last name of family and the word “FAMILY”/Click Align Text Right button; and
(b) Type “MONTH 1 ASSESSMENT”/Click Align Text left button.

### 2. Bottom of Graph:

(a) “Overall Family Functionality Score” box
   (i) format far right column for “Mth-yy”/enter Current month assessed completed; and
   (ii) enter in the % score from the Monthly Summary Sheet (M1 Column).

### 3. Graph

(a) Make sure the Family Composite Score on the far left “circle” is correct;
(b) Right click on graph/click “Source Data”/Click on “series”;
   (i) Click “Add”, Type in “PREVIOUS”;
   (ii) Add data from Monthly Summary Sheet from M1 Column;
(c) Format Plot Area to Light Blue;
(d) Place M1 bars inside BL bars on graph;
(e) Format the % score for each bar showing in each outcome indicator; and
(f) Color each bar for each outcome indictor the appropriate color (red, yellow, or green).
   Month 2 (and subsequent) Graph Formatting
   1. Graph Heading: [Font Size between 24-36/Bold]
(a) Type on right side last name of family and the word “FAMILY”/Click Align Text Right button; and
(b) Type “MONTH 2 (or appropriate month #) ASSESSMENT”/Click Align Text left button.

### 2. Bottom of Graph:

(a) “Overall Family Functionality Score” box
   (i) format far right column for “Mth-yy”/enter Current month assessed completed; and
   (ii) enter in the % score from the Monthly Summary Sheet (M2 (M#) Column).

### 3. Graph

(a) Make sure the Composite Client Success Score on the far left “circle” is correct;
(b) Right click on graph/click “Source Data”/Click on “series”;
   (i) Click “Add”, Type in “CURRENT”;
   (ii) Add data from Monthly Summary Sheet from M1 Column; and
(c) Click on Graph/select “Chart Type”/select “Line-Column 2 Axis” from Custom Types;
(d) Format Plot Area to Light Blue;
(e) Format y-axis and x-axis to Font 10-bold-Dark Blue;
(d) Format the % score for each bar and line showing in each outcome indicator; and
(f) Color each bar and Marker (triangle) for each outcome indicator is the appropriate color (red, yellow, or green).

This patent disclosure pertains to an embodiment of computer software program and applications that can be used by human services professionals and paraprofessionals to complete tasks associated with professional and paraprofessional activities, competencies, duties and responsibilities. The computer software is an “Outcomes Generator” software application for all relevant responsibilities and duties that a human services professional and/or paraprofessional does on a day-to-day basis and over the course of their career. The computer software application will contain applications that will expedite and enhance the process by which human services professionals and paraprofessionals conduct their business and activities, responsibilities and duties related to the assessment of their interventions with clients involved in a human service delivery system. A human service delivery system is defined as a recognized system of oversight, direct services, documentation and applied interventions applied to individuals and/or families by a duly recognized entity and/or professional or paraprofessional for the provision of such services that assist to correct, mitigate, meliorate and/or otherwise change a client's present condition, which has been determined to be detrimental to their physical, emotional, psychological, spiritual, mental condition through an applied and recognized intervention techniques.

The professional, paraprofessional and/or the entity in which they are employed will purchase the rights to use the computer software and its applications. The professional, paraprofessional and/or the entity in which they are employed will then gain access to the computer software via a secure username and password that will allow access to the web-based software and its applications. The computer software and applications will be maintained on a dedicated computer server and all data collected will be maintained on a secure and dedicated server in which professionals, paraprofessionals and/or the entity they are employed by have retained the proper rights of use of the computer software and its applications. Those with proper rights of use will access the computer software and its application via a computer with an Internet connection. The computer's operating system software would then interface with the computer's hardware to execute the applications of the computer software. The computer software program can be written in any high-level programming language, machine language, and/or assembly language that exist or yet has been discovered and be compiled, interpreted, and/or assembled into machine language object code by any means that exist or has yet to be discovered. The human services professional and/or paraprofessional or the entity in which they are employed will interface with the computer software and its applications to facilitate their duties, activities, and responsibilities by inputting data via various graphical user interfaces and receiving outputs. The instructions and execution of the computer software program and its applications would be housed within the language of the software itself and would be passed through to the aforementioned machine language. These instructions will make the computer facilitate the applications and operations of the computer software program and will allow human services professional and paraprofessional to carry out their duties, activity and responsibilities. The instructions can be performed sequentially, conditionally or in an iterative manner depending on the human services professional and/or paraprofessional's need. The communication between users and the interconnection of Internet and/or communication networks of the human services professional an d/or paraprofessional between various human services entities, businesses, organizations and/or institutions will be facilitated through any means that exist or has yet to be discovered.

The computer software program and its applications have been designed to allow for sensitive information to be exchanged between human services entities, organizations, businesses, and/or institutions and as such, any form of communication security mechanisms can be used to create the direct, secure electronic linkages between duly authorized users, entities, business, organization and/or institutions and/or their computer/communication networks. Actions, activity and applications of the computer software program and its applications will occur between the respective computer servers of the human services entities, organizations, businesses and/or institutions as these entities interact with one another for the completion of their professional and/or paraprofessional duties, activities and responsibilities. The registration and creation of a direct secured electronic linkage is of paramount importance within this patent disclosure so that information and data sent through the linkage can be encrypted at any existing or yet to be discovered bit level to ensure protection and security of all data. The inputting of data by human service professionals and/or paraprofessionals can be done by any means that exist or have yet to be discovered.

The computer software program and its applications will be associated with the creation of outcome areas, outcome indicators associated with specific outcome areas, indicator standards associated with specific outcome and indicators and observable measures that will be associated with specific outcome indicators. The application will also produce a defined scoring scale to be used in conjunction with the indicator standard to assist the human services professional and/or paraprofessional to score the observable measures. The outcome indicator will also be associated to various types of human services interventions in which the human services professional and paraprofessional will use to determine which outcome area, outcome indicator and standard and subsequent observable measures that will be scored given the particular intervention applied.

The Outcome Area is defined as the overarching area in which outcome indicators, standards and observable data measures will be defined to demonstrate the impact service is having with family, child, or individual clients and on the human service delivery system as an aggregate.

The Outcome indicator and Standard is defined as the method that the end user can apply their scoring of observable measures based on this standard. The standard developed will provide the structure which determines and justifies the score given to each observable measure.

The Observable measure is defined as the a method and process and template to provide quantitative data collected during the reporting period that is used to collaborate the empirical scoring data completed by the end user.

Collectively these creations of outcome area, outcome indicator, indicator standard, observable measures and the defined scoring scale is called the “Assessment Process” to be completed by the human service professional and/or paraprofessional. Within the computer software there will be applications that allow for users to enter in relevant information pertaining to the definition of an outcome area, the associated outcome indictor(s), standard(s) and observable measures(s). Within the computer software application, the user will have the ability to access these creations as a method of entering in data to complete the “assessment process”. This process allows for the user to enter in reliable and valid data for the purpose of record keeping and completion of the “Assessment Process”. The templates for the outcome area(s), outcome indicator(s), indicator standard(s), and observable measure(s) can be of any design or structure that exist or has yet to be discovered. The user will type in the data associated with the outcome area(s), outcome indicator(s), indicator standard(s) and observable measure(s) and once approved by the duly authorized user will be saved to the dedicated server and storage device that can save data in any manner that exists or has yet to be discovered. The computer software program and its applications will allow for the user to directly, securely and electronically send their data in a portable file to an authorized human services agencies, organization, business and/or entity that exist or has yet to be discovered. This activity and/or action will be completed after the user has registered their credentials for authorize use of the computer software program. This registration will allow for the creation of the direct, secure and electronic linkages to send data. The computer software program and its applications will users to create a direct, secure and electronic linkage to human service entities at the state level, county level and/or service provider level that exist or has yet to be discovered that will allow the completed assessment process to be sent as a portable file. This process will expedite the ability of human service entities to review, analyze and use the data collected in manner that will allow the data to have meaning to the respective user and the entity conducting the review and analysis of the data. The data transmitted via a direct, secure linkage must be secured to protect the confidential nature of the data being sent to ensure confidentiality of clients and associated professional duties. The method to protect the data can be any method that exist or has yet to be discovered and one such embodiment of a method could be, but not limited to, a secure web-based interface between the computer software program and its applications and the human service entities sending and receiving the data being sent or received. Another method would be to have all end users register for authorization of use of the computer software program and its applications via a unique user name and unique password to gain access to the data and the computer software program and its applications.

The computer software program and its applications will provide the user with direct, secure and electronic linkages with other human service organizations, entities, businesses, and/or institutions that are authorized users of the computer software program and its applications so that the user can send enter data and save data to a portable file and receive data and information related to their professional and paraprofessional activities, duties and responsibilities. The user will have access to confidential client records that pertain directly to their professional and paraprofessional duties, activities and responsibilities and will allow the user to enter, view and otherwise access data pertaining to their particular clients within a human service delivery system. The user will have access as long as their registration credentials remain valid to the computer software program and its applications.

The human services professionals and paraprofessionals will complete the Assessment Process for their assigned clients on a routine basis, typically within 30 days of the initial introduction of the intervention being applied and every 30 days subsequent. Human services professional and paraprofessionals need proper training in order to accurately and consistently complete the assessment process. There are three (3) levels in which training can occur; (1) State level training will be in the completion of the Outcome Area, Outcome Indicator and Standard and Observable measure as well as training in the use of the defined scoring scale, and completion of analytical applications available within the computer software program, (2) County level training will be in the completion of the Outcome Area, Outcome Indicator and Standard and Observable measure as well as training in the use of the defined scoring scale, and completion of analytical applications available within the computer software program, users will also be trained in the proper use of data entered into the program, editing data in the program and utilizing the referral process appropriately within the system (3) Service Provider level training to review and train human service professionals and paraprofessionals of the proper methodology to accept referrals from the County agencies, complete the assessment process and allow for data to be sent to the appropriate county level agency All levels will receive training of the entire computer software program and its applications to assist in the efficient and effective use of the computer software program and its applications. This process will allow for quick and efficient use of the software and its applications in the completion of the assessment process.

The computer software program and its applications will provide a generated graphic depiction of the data collected and analyzed through a propriety algorithm that will take the scoring completed by the human service professional and paraprofessional and through mathematical calculations convert the scores of observable measures into percentages of success scores that will be used to alert the user as to the level of success the client is having in a particular outcome indicator and outcome area. The calculations will be contained within the computer software program and its applications and the user will have no access to the calculations or the ability to change, alter or otherwise manipulate the conversion of raw score data into the success percentage scores. The computer software program will also calculate an initial baseline score for each intervention/outcome indicator, and observable measure that will be used to provide the foundation in which client success will be measured. The baseline score will serve as the anchor for calculating the client change of success in any given outcome area. This baseline score once established and approved will not be able to be altered, edited or otherwise manipulated. Subsequent scoring of the same outcome indicators and observable measures will take place approximately every thirty (30) days from the completion of the initial baseline score and will be calculated in the same method. These subsequent scores will be utilized to determine the change a client is making in relation to their baseline score. Each subsequent month will be calculated to provided a composite scoring and change to success relative to the baseline scoring as opposed to being measured individually against the baseline scoring. This methodology will be applied to all clients participating in a human service delivery system with an authorized user/service provider of the computer software program and its applications.

The computer software program and its applications will also be used to collect, store and analyze data on an aggregate level for each of the identified outcome areas and provide agencies with the ability to perform meta-analysis of data collected through various methods within the computer software program and its applications. One embodiment of the meta-analysis, but not limited, would be the ability of the State level agency to access data to determine the success of an intervention applied to a certain number of geographical areas, for a certain client age group, and a particular race and/or gender of the population of clients receiving services. Another embodiment of the analysis could be the application of county agencies to determine the most effective interventions by a group of service provider agencies to a particular population of clients.

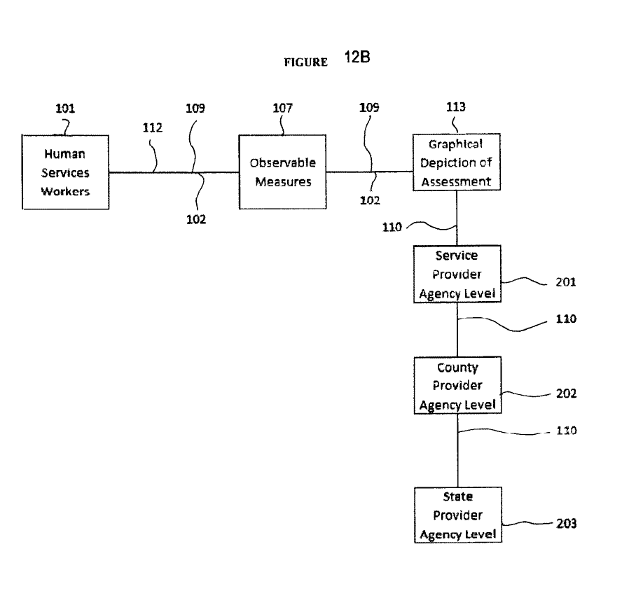

As shown in FIG. 11, the human services professional and/or paraprofessional (101) uses the computer software program and its applications (102) that contains templates for the Outcome Area(s)(104), the Outcome Indicator(s) (105), Indicator Standard(s) (106) and the Observable Measure(s) (107). The templates are created by the user or are preinstalled (103) or are uploaded into the computer software program (102) and enters data (109) onto the observable measures template (105) guided by the indicator standard (106) and the defined scoring scale (108) and saves the data to a storage device (111) that exist or has yet to be discovered. The user (101) will register (112) in order to access the templates and software either as an individual human services professional and/or paraprofessional or part of a human services state agency, county agency, service provider agency, educational institution and/or insurance company (114) that exist or has yet to be discovered. The human services professional and/or paraprofessional (101) sends and receives data (109) through a direct, secure and electronic linkage (110) that exist or has yet to be discovered. The receiving entity (114) of the data approves the data and sends data to a storage device (111) that exist or has yet to be discovered. The sending and receiving of data (109) is created via the registration (112) of humans services professionals and/or paraprofessionals (101) of the computer software program and its applications (102).

FIG. 11 shows human services professionals data collection and evaluation of client response to interventions applied using the computer program software using templates and/or designs as well as the direct electronic linkages and delivery of said data collection and assessment and graphic depiction of results to State human service agencies, County Human service agencies, Service Provider service agencies, Educational institutions, Insurance companies and any other business that exist and/or has yet been discovered;

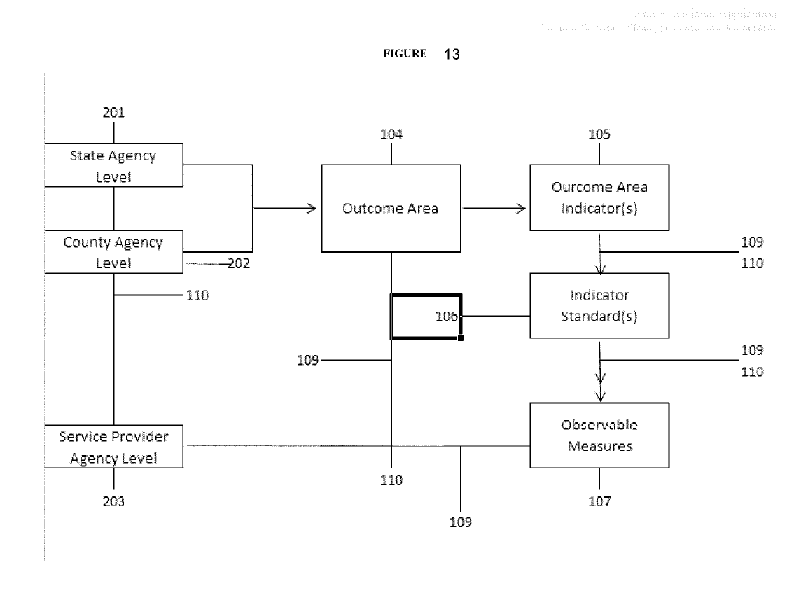

FIGS. 12A and 12B show the ability of the development of outcome areas, outcome indicators associated to each Outcome area, associated indicator standards to the outcome indicators, and the observable measures that are associated with each outcome indicator. They also depict the ability of human service professionals collect data and information from clients and interventions applied and its applications using the computer software program via direct, secure and electronic linkages with various human services agencies, businesses, organizations and entities that exists or has yet been discovered.

As shown in FIG. 12A, the human services professional and paraprofessional (101) at the State agency entity (201) and the County agency entity (202) work in collaboration to create the outcome area(s) (104), Outcome Indicator(s) (105), indicator standard(s) (106) and then works collaboratively to created the observable measure(s) (107) with the Service provider entity (203). This process allows data (109) to be transmitted between the agencies via a direct, secure and electronic linkages (110) through the computer software program and its applications (102). The state agency (201) has final authorization and approval of the outcome area(s) (104), outcome indicator(s) (105), indicator standard(s) (106) and the observable measure(s) (107).

As shown in FIG. 12B, the human services professional and/or paraprofessional (101) upon proper registration (112) is able to receive and send data via a direct, secure and electronic linkage (110) to view the observable measures (107) of a given intervention and outcome indicator. Using the defined scoring standard (108) the human services professional and/or paraprofessional (101) applies scores to each of the observable measures (104). The data (109) entered produces a graphical depiction (113) of the scoring prescribed to the observable measures (107). Through a direct, secure and electronic linkage (110) the data (109) is saved by the service provider entity (201) and is sent to the county agency entity (202) for review and approval. Once approved by the county agency entity (202) has approved the data (109) the data (109) is stored and available to the state agency entity (203) in both individual form as well as aggregate data (109).

FIG. 13 shows the flow of work activities performed at the State Agency level, County Agency level and Service Provider level. State Agencies define the outcome areas, State and County agencies working in collaboration define the outcome indicators to be associated within each of the outcome areas. They also define the indicator standard that is applied to each outcome indicator. The final step is to define the observable measures that will be used by the Service Provider level agencies to apply the defined scoring measures when performing interventions applied and its applications using the computer software program via direct, secure and electronic linkages with various human services agencies, businesses, organizations and entities that exists or has yet been discovered.

As shown in FIG. 13, the completion of the outcome area (104) and associated outcome indicator(s)(105), indicator standard(s) (106), and observable measures (107), is available to view via a direct, secure and electronic linkage (110). All data (109) is accessible based on the entities current registration (112) which provides access to data (109) authorized to be viewed by the service provider entity (203), county agency entity (202) and state agency entity (201).

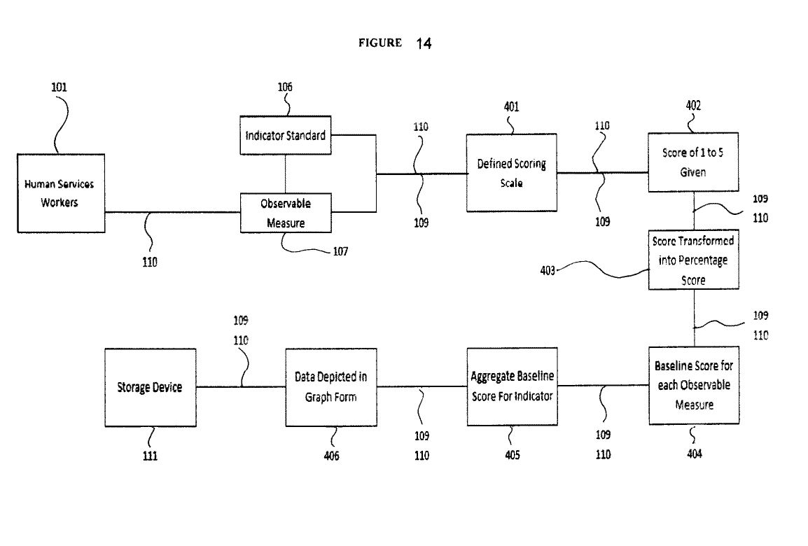

As shown in FIG. 14, the human services professional and/or paraprofessional (101) is able to view, through a direct, secure and electronic linkage (110), the indicator standard (106) in order to apply the defined scoring scale (401) to the proper observable measure (107). This process is repeated for each observable measure (107). The human services professional and/or paraprofessional apply the defined scoring scale (401) to the observable measure (107) on a scale of scoring from one (1) to (5) (402). Once completed with all observable measures (107) for the particular outcome indicator (106) the scores are computed via the computer software program and its applications (102) to produce a percentage score (403) for each observable measure (107) as well as an aggregate score for the outcome indicator (106). The initial scoring is defined as the client's baseline score (404), both for individual observable measures (107) as well as aggregate for outcome indicator (405). The computer software program and its applications (102) then transforms the data (109) into a graphical depiction (406) of the data. The data (109) is stored in a storage device (111) that exist or has yet to be discovered.

As shown in FIG. 15, once the scoring of one (1) to five (5) (402) has been completed, it represents the evidence of client's response to intervention (501) as applied by the human services professional and/or paraprofessional (101). The scoring is applied to each of the observable measures (404) and is stored in a memory device (502) within the computer software program (102) that exist or has yet to be created. The memory device (502) allows the human services professional and/or paraprofessional (101) to interrupt the process of scoring observable measures (107) and return to complete the activity and/or action. Once completed the data (109) is available to users who have been properly registered (112) to access the data (109) within a human service entity (114).

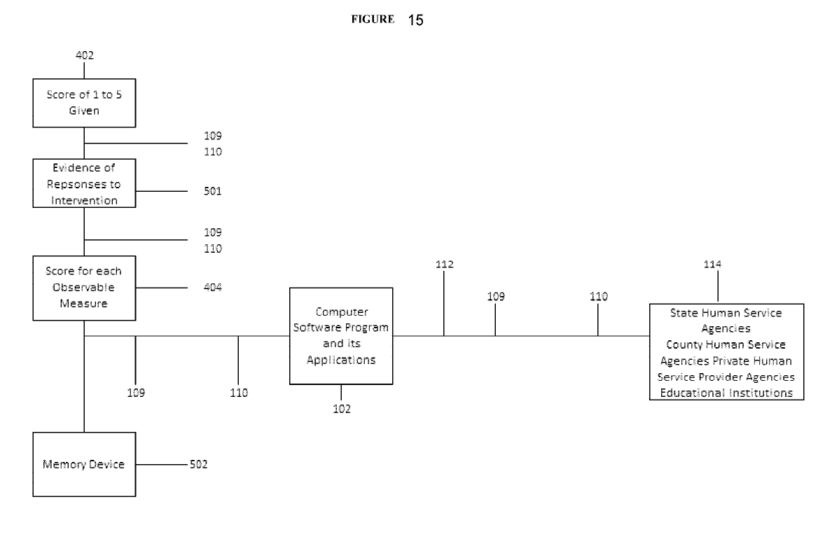

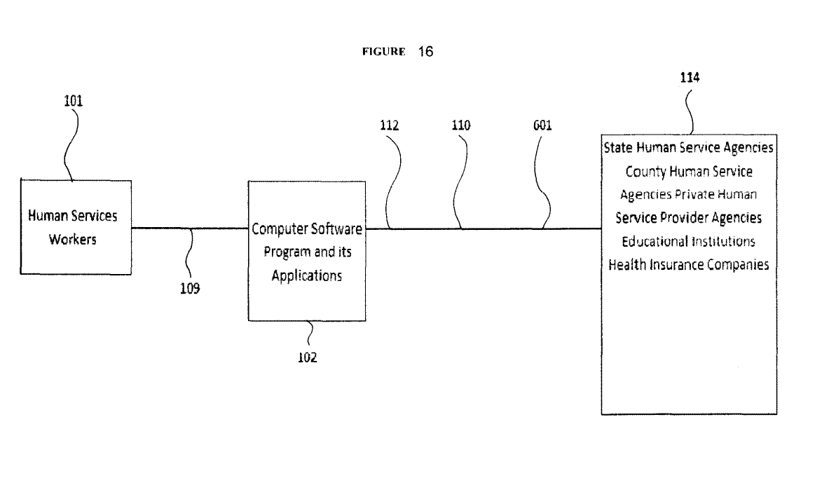

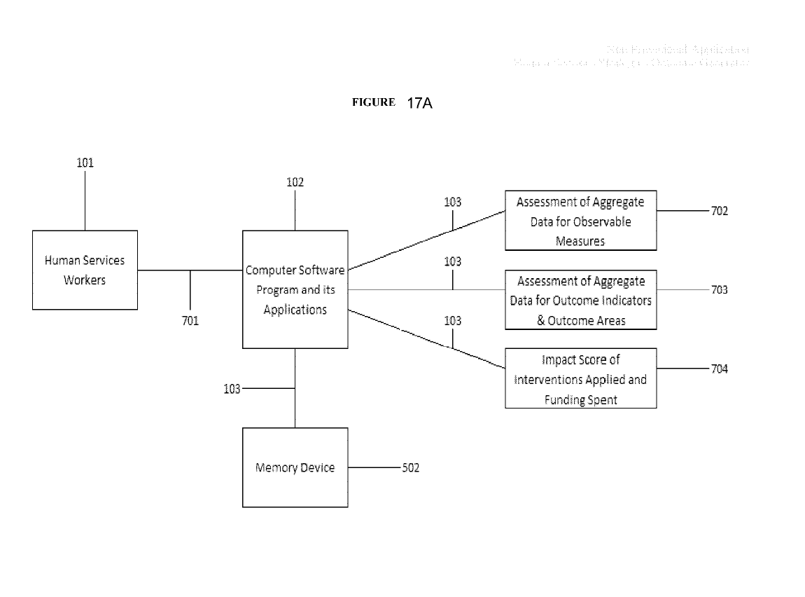

As shown in FIG. 16, the human services professional and/or paraprofessional (101) from a human services entity (114) will have access to the data (109) of the computer software program and its applications (102) through a direct, secure and electronic linkage (110) once registered (112) with a username and password.

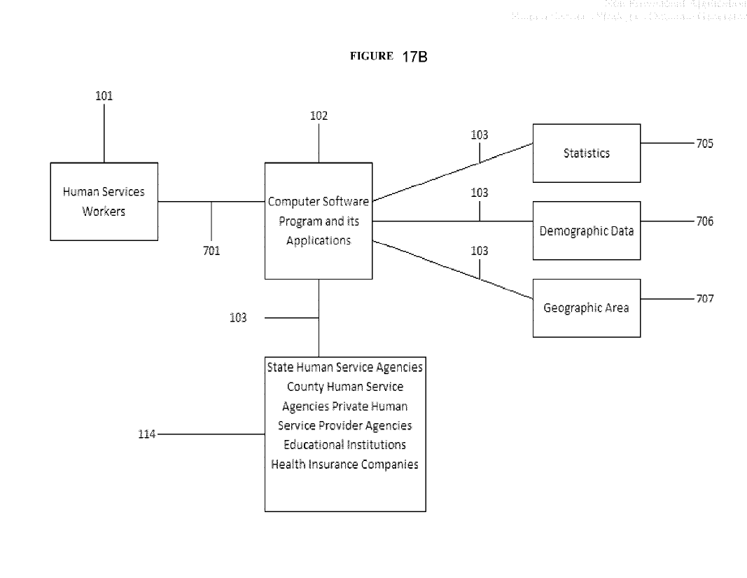

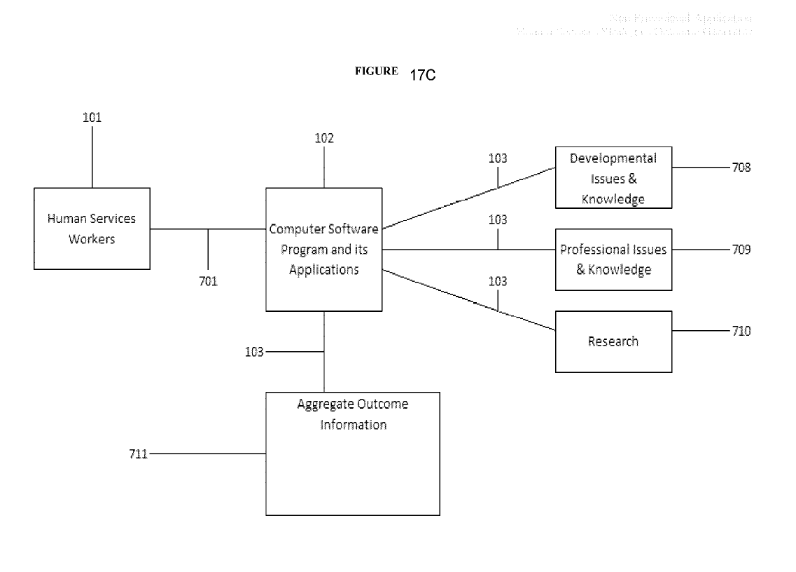

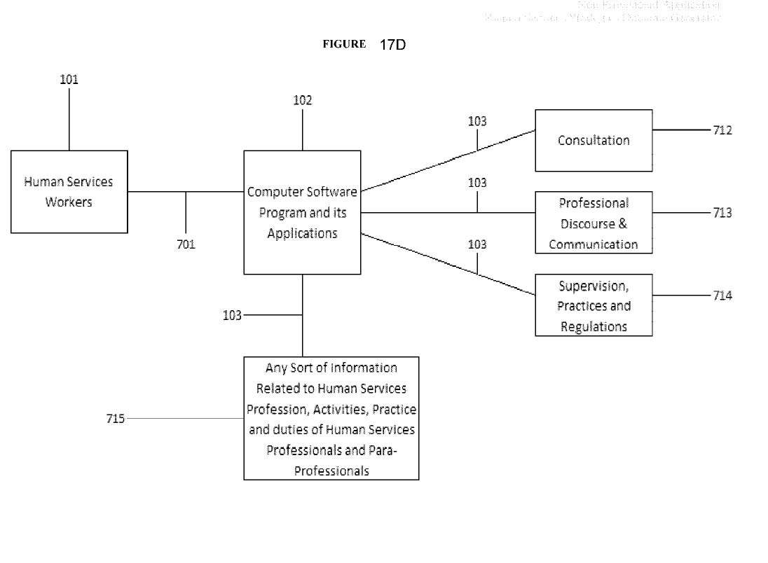

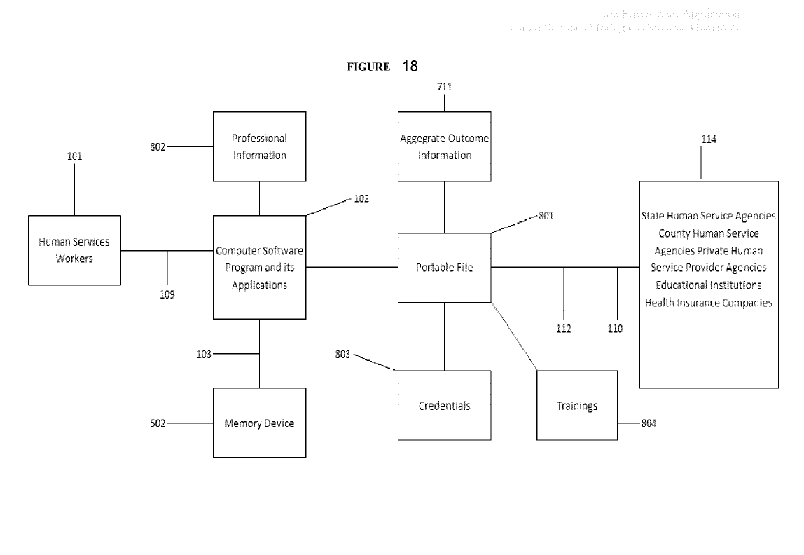

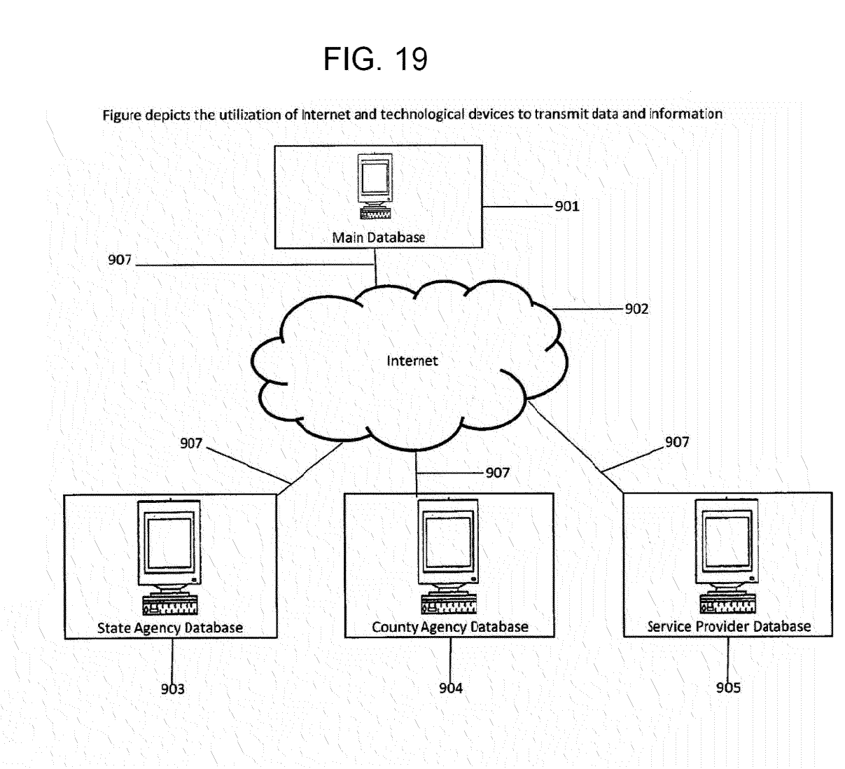

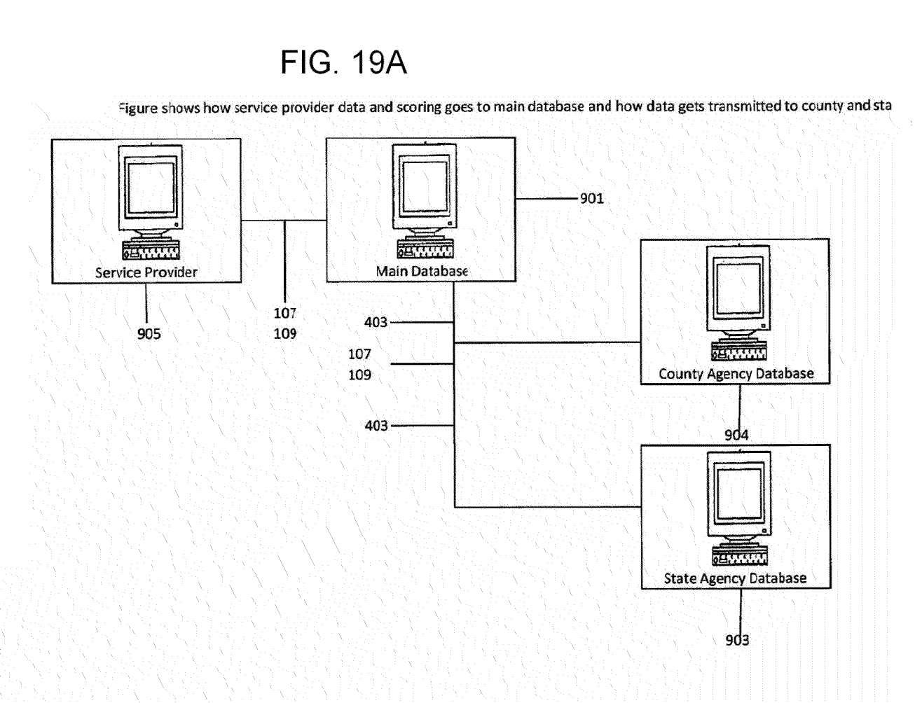

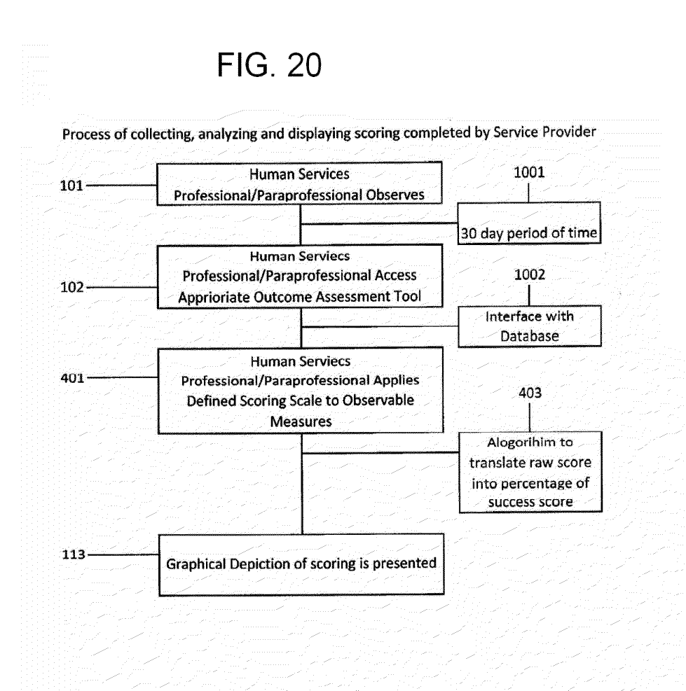

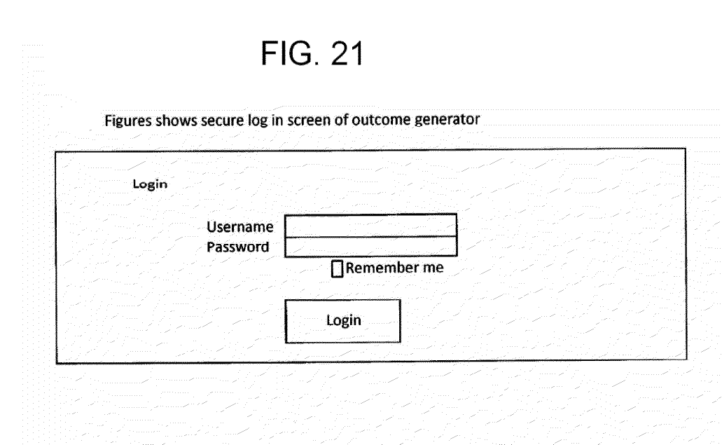

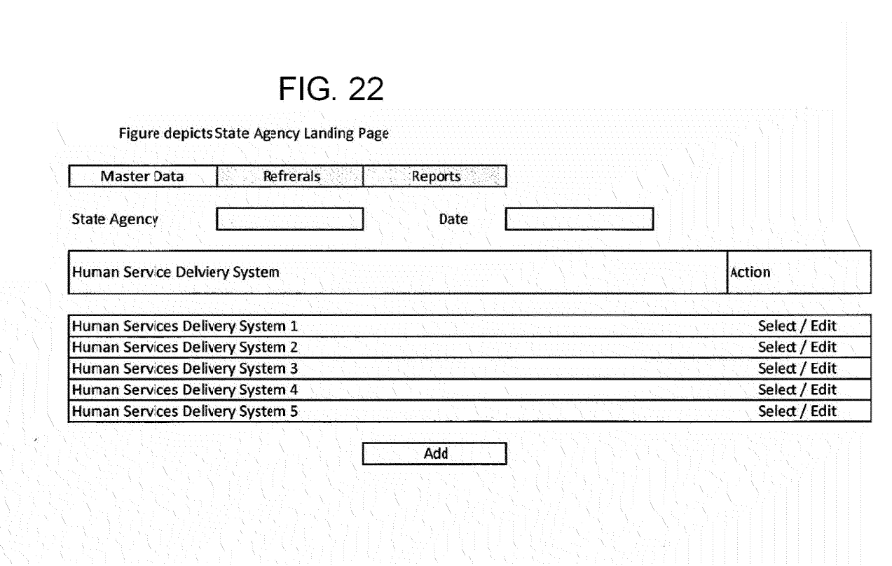

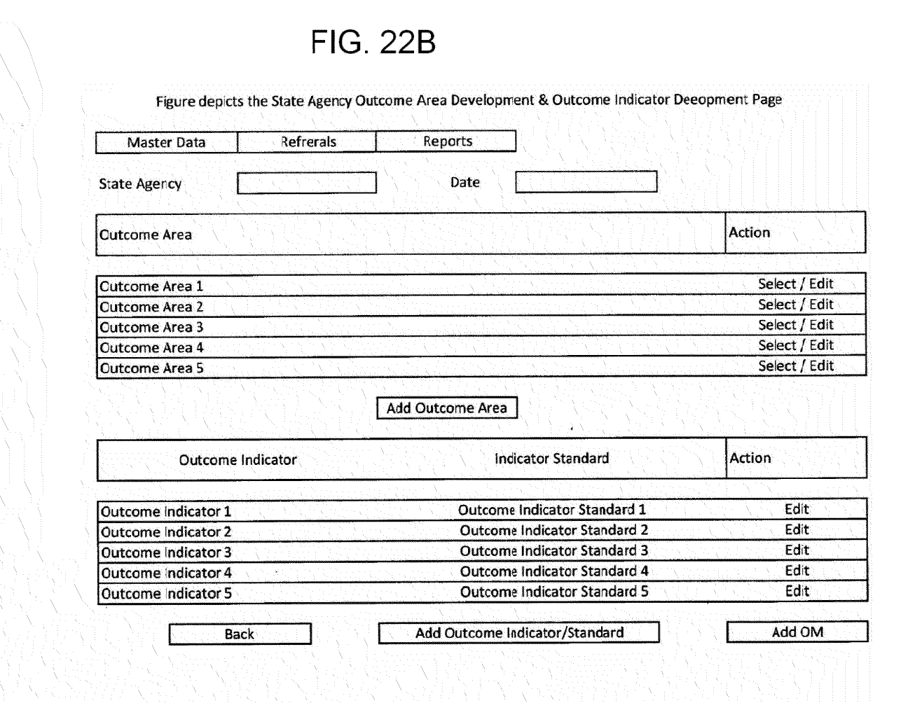

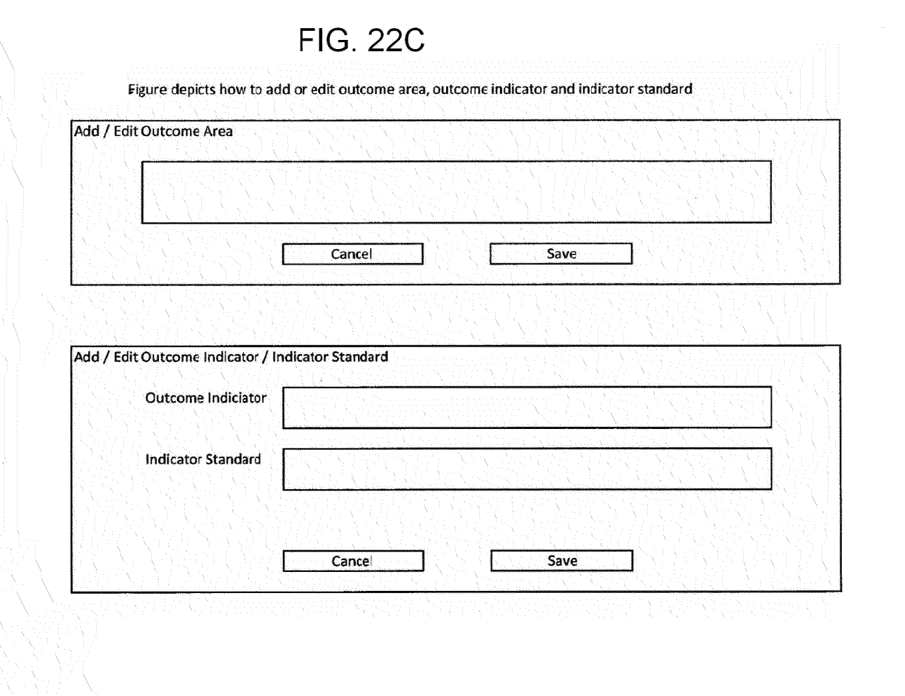

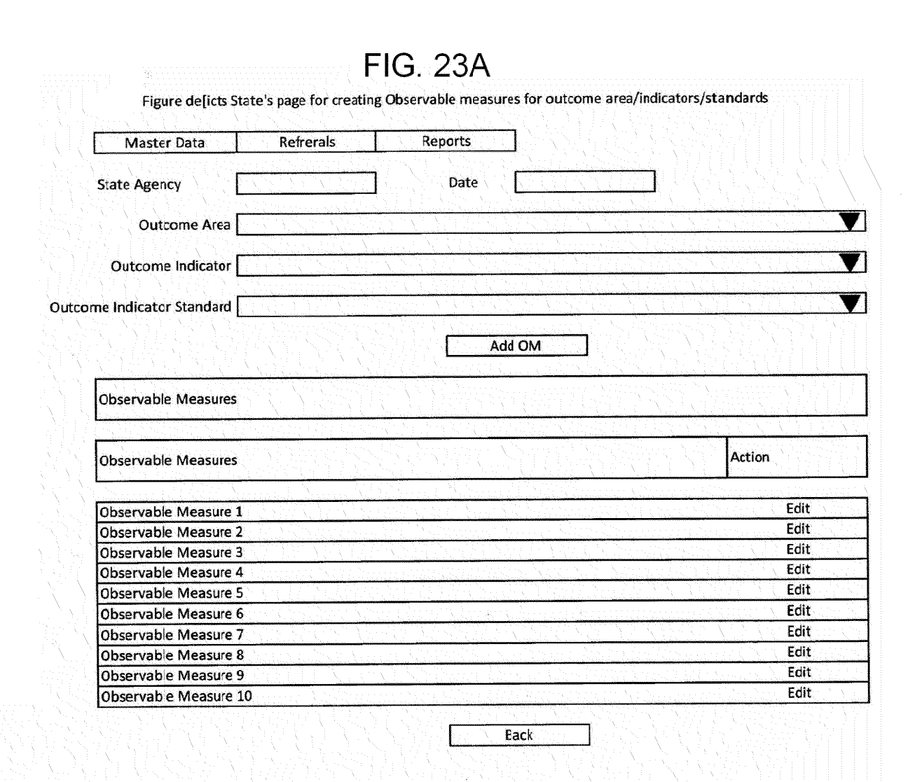

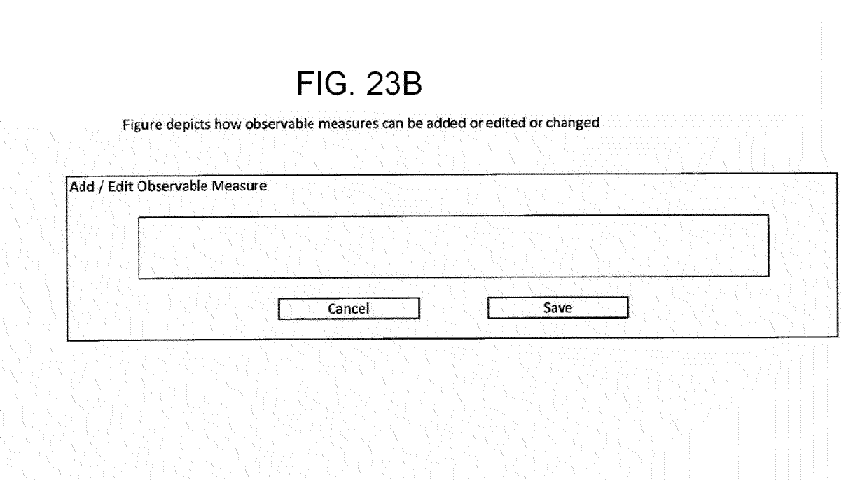

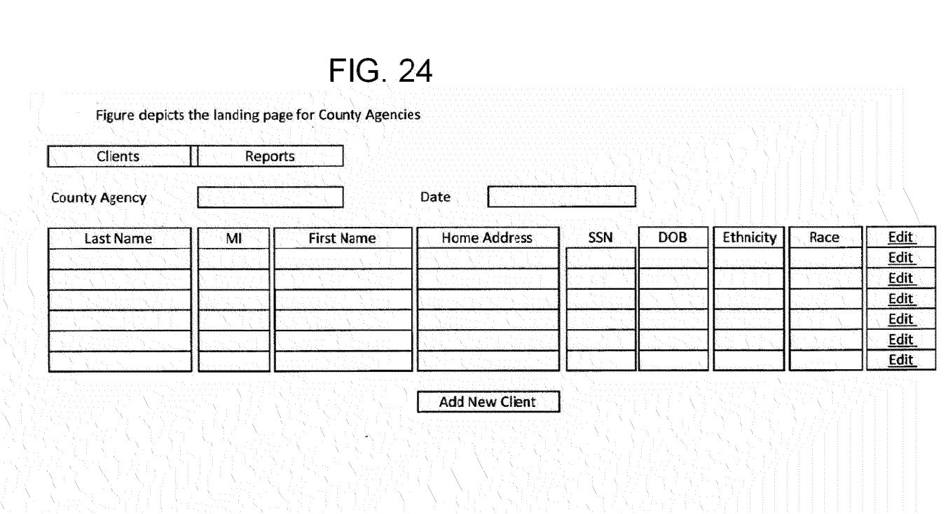

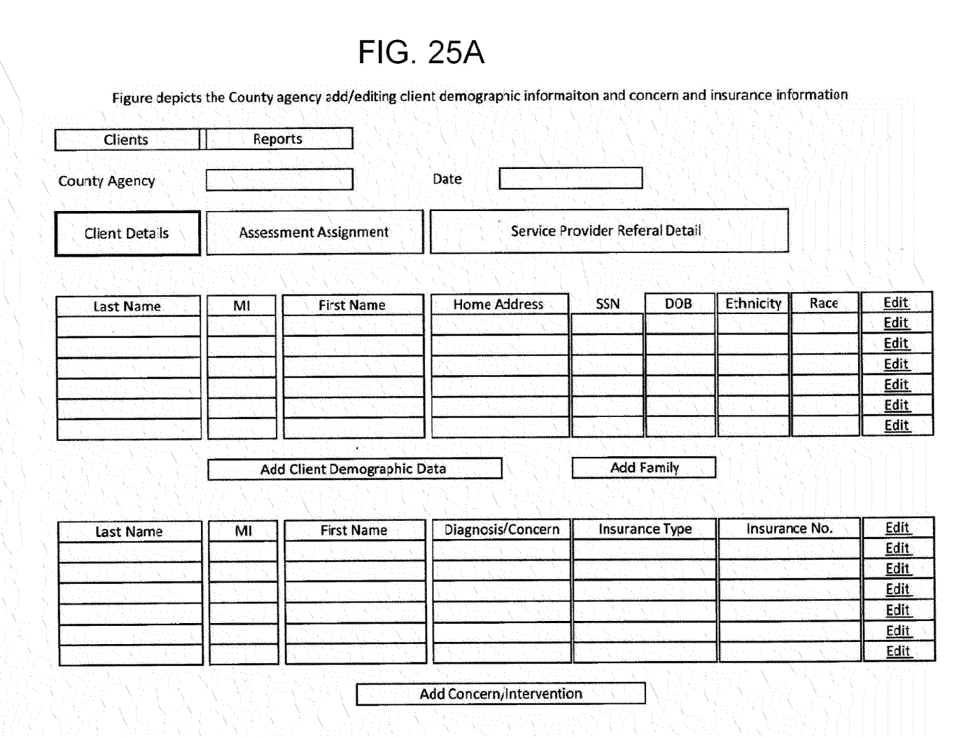

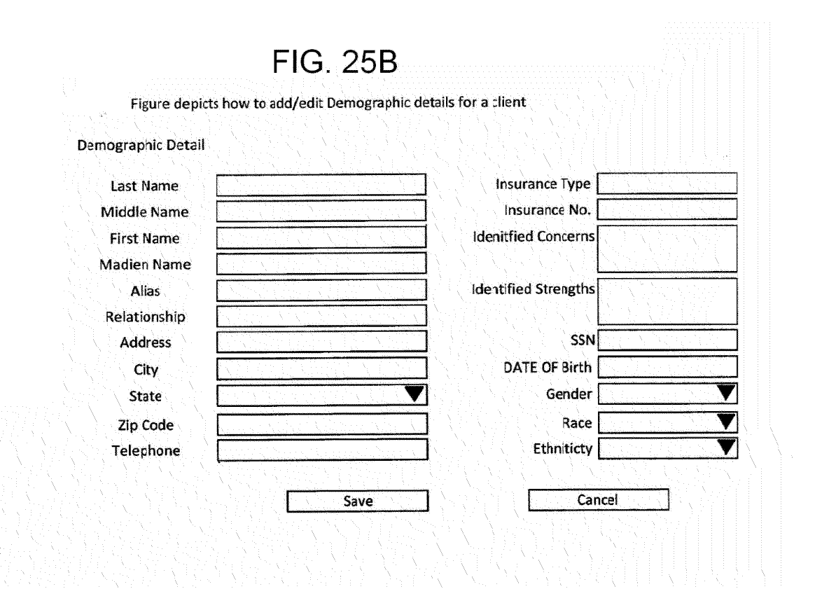

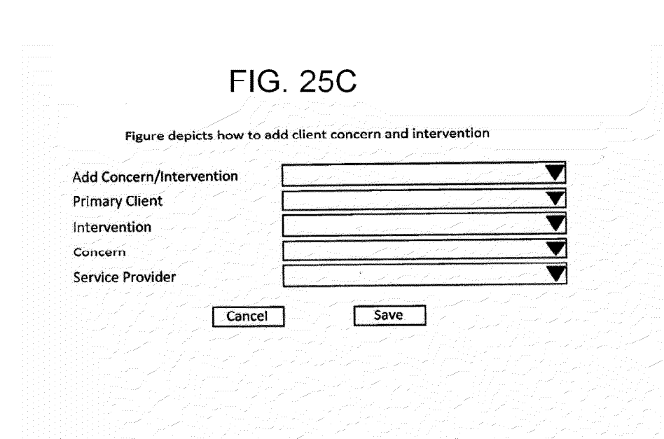

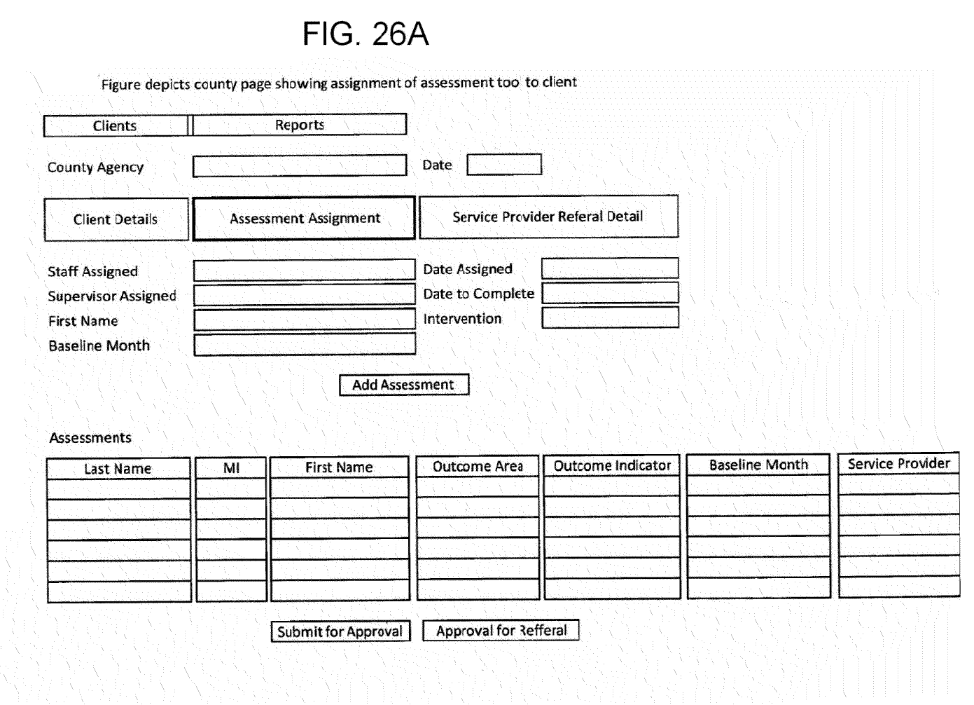

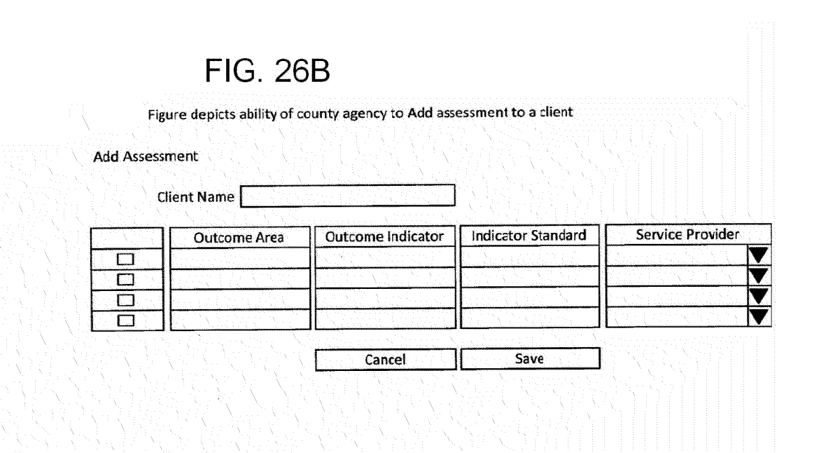

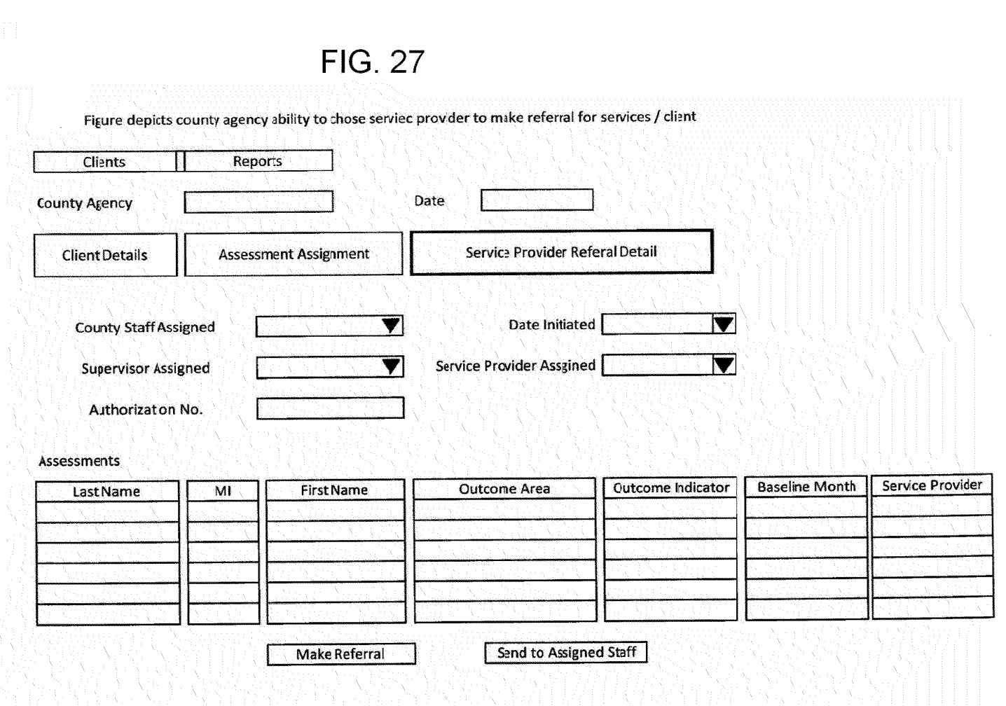

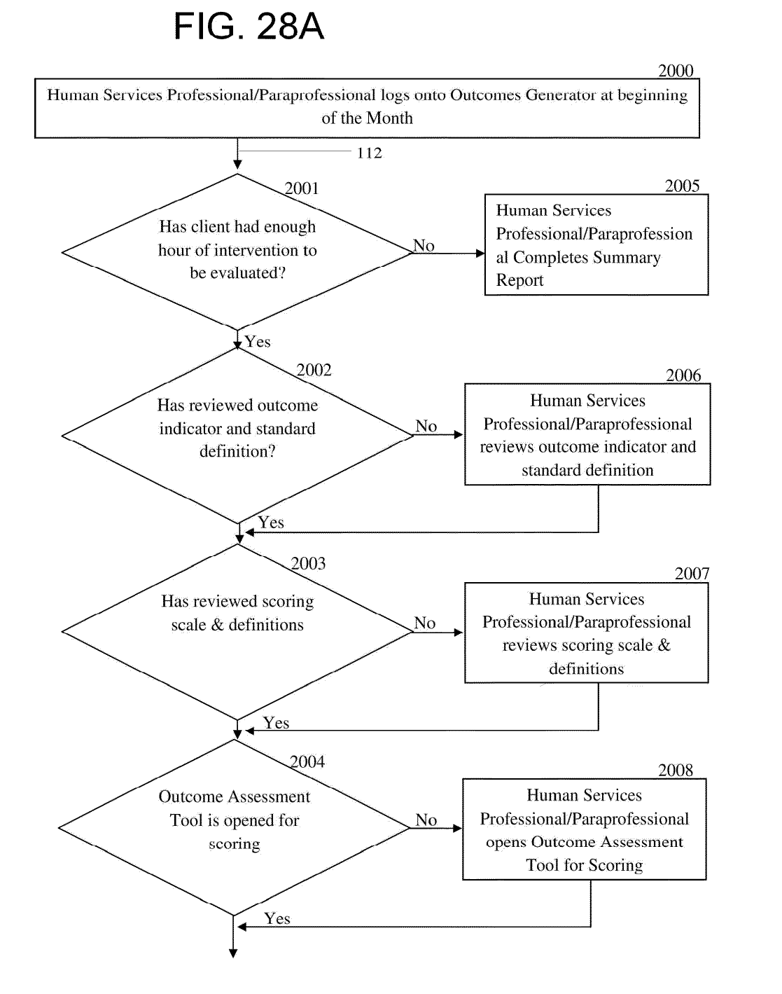

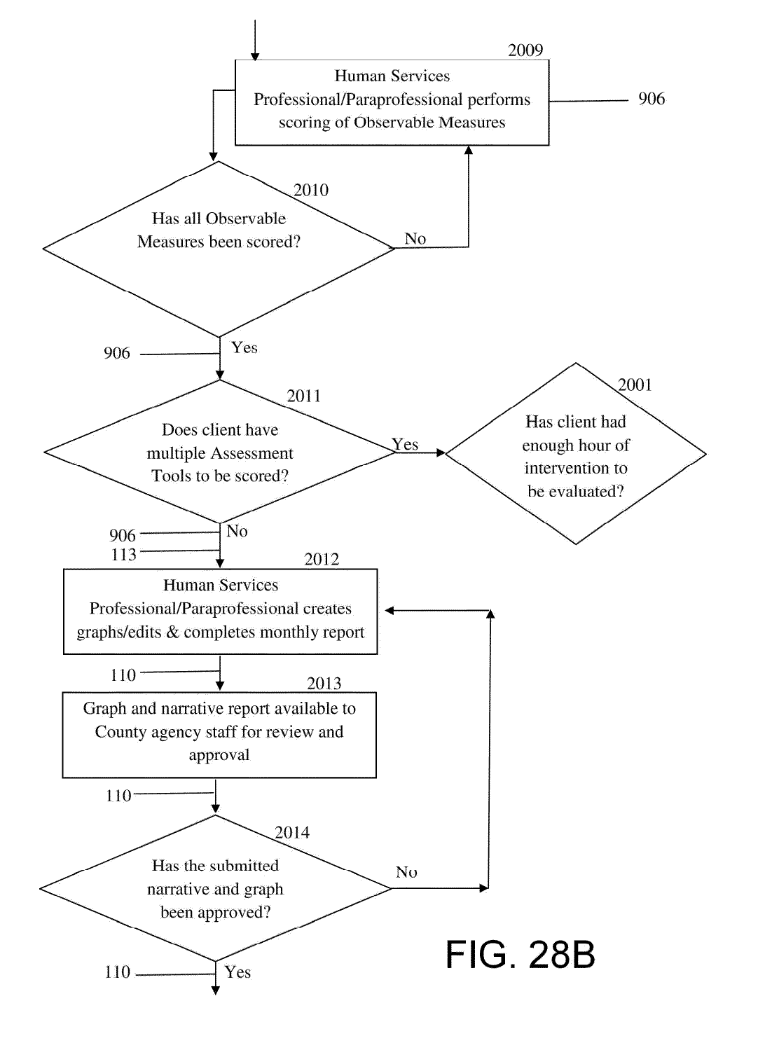

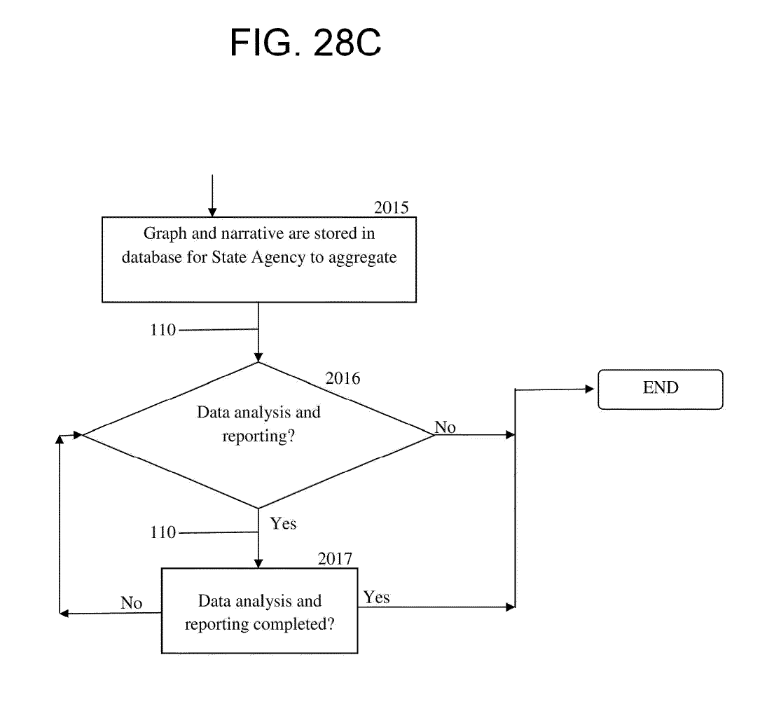

FIG. 17A depicts how the user (101) of the computer software program and its applications (102) can access information and data (109) assessment of aggregate data (702-703-704) that is related to the completion of data (109) for observable measures, outcome indictors and outcome areas. The computer software program and its applications (102) will have information and designs preinstalled (103) available to the user (101) once the user (101) has the designation of right to use (701) via the registration (112) process. The information (702,703,704) will come from the human services professionals and paraprofessionals (101) at the service provider entity (203) who have completed the assessment process and had assessments approved at the county agency entity (202) and stored in a memory device (502) that exist or has yet to be discovered. Access to the data results will be dependent upon the user's (101) registration (112) and authorized access availability through the rights to use (701) designation.

FIG. 17B depicts how the user (101) of the computer software program and its applications (102) can access information and data (109) related to statistical data (705), demographic data (706) and geographical areas (707) related to clients participating in a human service delivery system receiving interventions from a human services entity (114). The information provided (705, 706, 707) that is related to the completion of data (109) entered into the computer software program and its applications (102) will have information and designs preinstalled (103) available to the user (101) once the user (101) has the designation of right to use (701) via the registration (112) process. The information (705,706,707) will come from the human services professionals and paraprofessionals (101) at the county provider entity (202) who have completed the data entry process and had information and data (109) approved at the county agency entity (202) and stored in a memory device (502) that exist or has yet to be discovered. Access to the data results will be dependent upon the user's (101) registration (112) and authorized access availability through the rights to use (701) designation.

FIG. 17C depicts how the user (101) of the computer software program and its applications (102) can access information and knowledge that is analyzed by the aggregate outcome information (711) that is collected and stored in the computer software program and its applications (102). The collection of developmental issues and knowledge (708), professional issues and knowledge (709) and other research (710) that exist or has yet to be discovered will be stored for access from human services professionals and/or paraprofessionals (101). Access to the information (708, 709, 710) will be dependent upon the user's (101) registration (112) and authorized access availability through the rights to use (701) designation.

FIG. 17D depicts how the user (101) of the computer software program and its applications (102) can access information and knowledge that is developed through any sort of information related to human services, activities, practices and duties of human services professionals and/or paraprofessionals (715) that is collected and stored in the computer software program and its applications (102). The user (101) will have access to consultation (712), professional discourse and communication (713) and supervisor of practices and regulations via other humans services professionals and paraprofessionals (101). that exist or has yet to be discovered will be stored for access from human services professionals and/or paraprofessionals (101). Access to the information (712. 713, 715) will be dependent upon the user's (101) registration (112) and authorized access availability through the rights to use (701) designation.

FIG. 18 depicts the user (101) being able to enter data (109) into the computer software program and its applications (102) including their professional information (802) related to their human services entity (114) in which they work and their contact information and be able to have the data (109) saved to a memory device that exist or has yet to be discovered. This information (802) can be part of a portable file (801) that can be associated to the human services professional and/or paraprofessional's current caseload in which there is completed outcome data (109) in the form of aggregate outcome information (711) that can be part of any credentialing (803) process and training schedule (804) that pertains to the human services professional and/or paraprofessional (101) and through a direct, secure and electronic linkage (110) that data can be viewed by the properly authorized user (101) at the state, county and/or service provider entity or any other authorized entity (114) via registration (112) with the computer software program and its applications (102).
Example of Human Services Strategies Outcome Generator Human Services Delivery System: Child Welfare

Outcome Area: Child Safety

Outcome Indicator: Relationship Stability

Indicator Standard: To define and engage in healthy relationships that produces non-negative results on a consistent basis.

Observable Measures:

1. Consistently knows the background and current activities of spouse/partner.
2. Has less than 2 partners in a 12 month period.
3. Has not allowed a partner to verbally degrade them.
4. Has not allowed a partner to physically hurt them.
5. Is able to communicate effectively with partner.
6. Children's needs are placed above parent's needs.
7. Does not allow spouse/partner to dominate them.
8. Does not have a history of Protection from Abuse orders or other legal environment.
9. Allows self needs to be met in relationship.
10. History of ending relationships without negative events. Scoring Scale:
(1) Unable to meet Standard—client(s) is unable to function at a normative level that is consistent for the safety, permanency and/or well being of the child.
(2) Below Standard—Client(s) can function on a normative level with constant support that is consistent for the safety, permanency and/or well being of the child.
(3) Meets Standard—Client(s) is able to function at a normative level with intermediate support that is consistent for the safety, permanency and/or well being of the child.
(4) Exceeds Standard—Client(s) is able to function at a normative level with low support that is consistent for the safety, permanency and/or well being of the child.
(5) Superior—Client(s) functions at a normative level without support that is consistent for the safety, permanency and/or well being of the child.

Intervention Applied: Counseling—Relationship Counseling

### Process/Methodology

Human Services Professional meets with couple and begins providing intervention. After 30 days and with enough information and data to complete the scoring of the observable measures the professional initiates the baseline assessment. Using the Indicator Standard and the defined scoring scale the professional completes the following assessment:

Professional scores first parent/spouse response to intervention for a BASELINE score, as shown in example Table 1:

| | | | Rating as of the end of | | | | | | | | | | |
|---|---|---|---|---|---|---|---|---|---|---|---|---|---|
| Caretaker/ | | | M | M | M | M | M | M | M | M | M | Cumulative | |
| Parent 1 | Spouse #1 | BL | 1 | 2 | 3 | 4 | 5 | 6 | 7 | 8 | 9 | Total | Percent |
| 1. Consistently knows the | | 3 | 0 | 0 | 0 | 0 | 0 | 0 | 0 | 0 | 0 | 3 | 0% |
| background and current | | | | | | | | | | | | | |
| activities of spouse/partner | | | | | | | | | | | | | |
| 2. Has less than 2 partners | | 3 | 0 | 0 | 0 | 0 | 0 | 0 | 0 | 0 | 0 | 3 | 0% |
| in a 12 month period | | | | | | | | | | | | | |
| 3. Has not allowed a partner | | 3 | 0 | 0 | 0 | 0 | 0 | 0 | 0 | 0 | 0 | 3 | 0% |
| to verbally degrade them | | | | | | | | | | | | | |
| 4. Has not allowed a partner | | 3 | 0 | 0 | 0 | 0 | 0 | 0 | 0 | 0 | 0 | 3 | 0% |
| to physically hurt them | | | | | | | | | | | | | |
| 5. Is able to communicate | | 3 | 0 | 0 | 0 | 0 | 0 | 0 | 0 | 0 | 0 | 3 | 0% |
| effectively with partner | | | | | | | | | | | | | |
| 6. Children's needs are | | 3 | 0 | 0 | 0 | 0 | 0 | 0 | 0 | 0 | 0 | 3 | 0% |
| placed above parent's needs | | | | | | | | | | | | | |
| 7. Does not allow spouse/ | | 3 | 0 | 0 | 0 | 0 | 0 | 0 | 0 | 0 | 0 | 3 | 0% |
| partner to dominate them | | | | | | | | | | | | | |
| 8. Does not have a history of | | 3 | 0 | 0 | 0 | 0 | 0 | 0 | 0 | 0 | 0 | 3 | 0% |
| Protection from Abuse orders | | | | | | | | | | | | | |
| or other legal environment | | | | | | | | | | | | | |
| 9. Allows self needs to be | | 3 | 0 | 0 | 0 | 0 | 0 | 0 | 0 | 0 | 0 | 3 | 0% |
| met in relationship | | | | | | | | | | | | | |
| 10. History of ending | | 3 | 0 | 0 | 0 | 0 | 0 | 0 | 0 | 0 | 0 | 3 | 0% |
| relationships without negative | | | | | | | | | | | | | |
| events | | | | | | | | | | | | | |
| Baseline and | Total | 3 | 0 | 0 | 0 | 0 | 0 | 0 | 0 | 0 | 0 | 3 | 60% |
| Monthly | Relationship | | | | | | | | | | | | |
| Progression | Stability | | | | | | | | | | | | |
| | Percentage of | 60% | 0 | 0 | 0 | 0 | 0 | 0 | 0 | 0 | 0 | 60% | |
| | Functionality | | | | | | | | | | | | |

Professional scores second parent/spouse response to intervention for a BASELINE score, as shown in example Table 2:

| | | | Rating as of the end of | | | | | | | | | | |
|---|---|---|---|---|---|---|---|---|---|---|---|---|---|
| Caretaker/ | | | M | M | M | M | M | M | M | M | M | Cumulative | |
| Parent 1 | Spouse #2 | BL | 1 | 2 | 3 | 4 | 5 | 6 | 7 | 8 | 9 | Total | Percent |
| 1. Consistently knows the | | 3 | 0 | 0 | 0 | 0 | 0 | 0 | 0 | 0 | 0 | 3 | 0% |
| background and current | | | | | | | | | | | | | |
| activities of spouse/partner | | | | | | | | | | | | | |
| 2. Has less than 2 partners | | 3 | 0 | 0 | 0 | 0 | 0 | 0 | 0 | 0 | 0 | 3 | 0% |
| in a 12 month period | | | | | | | | | | | | | |
| 3. Has not allowed a partner | | 3 | 0 | 0 | 0 | 0 | 0 | 0 | 0 | 0 | 0 | 3 | 0% |
| to verbally degrade them | | | | | | | | | | | | | |
| 4. Has not allowed a partner | | 3 | 0 | 0 | 0 | 0 | 0 | 0 | 0 | 0 | 0 | 3 | 0% |
| to physically hurt them | | | | | | | | | | | | | |
| 5. Is able to communicate | | 3 | 0 | 0 | 0 | 0 | 0 | 0 | 0 | 0 | 0 | 3 | 0% |
| effectively with partner | | | | | | | | | | | | | |
| 6. Children's needs are | | 3 | 0 | 0 | 0 | 0 | 0 | 0 | 0 | 0 | 0 | 3 | 0% |
| placed above parent's needs | | | | | | | | | | | | | |
| 7. Does not allow spouse/ | | 3 | 0 | 0 | 0 | 0 | 0 | 0 | 0 | 0 | 0 | 3 | 0% |
| partner to dominate them | | | | | | | | | | | | | |
| 8. Does not have a history of | | 3 | 0 | 0 | 0 | 0 | 0 | 0 | 0 | 0 | 0 | 3 | 0% |
| Protection from Abuse orders | | | | | | | | | | | | | |
| or other legal environment | | | | | | | | | | | | | |
| 9. Allows self needs to be | | 3 | 0 | 0 | 0 | 0 | 0 | 0 | 0 | 0 | 0 | 3 | 0% |
| met in relationship | | | | | | | | | | | | | |
| 10. History of ending | | 3 | 0 | 0 | 0 | 0 | 0 | 0 | 0 | 0 | 0 | 3 | 0% |
| relationships without negative | | | | | | | | | | | | | |
| events | | | | | | | | | | | | | |
| Baseline and | Total | 3 | 0 | 0 | 0 | 0 | 0 | 0 | 0 | 0 | 0 | 3 | 60% |
| Monthly | Relationship | | | | | | | | | | | | |
| Progression | Stability | | | | | | | | | | | | |
| | Percentage of | 60% | 0 | 0 | 0 | 0 | 0 | 0 | 0 | 0 | 0 | 60% | |
| | Functionality | | | | | | | | | | | | |

### Process/Methodology for Baseline & Subsequent Months Scoring

$$\begin{matrix}Score Total Algorithm \\ {Score}_{ObservableMeasure \#1} + {Score}_{ObservableMeasure \#2} + {Score}_{ObservableMeasure \#3} + {Score}_{ObservableMeasure \#4} + {Score}_{ObservableMeasure \#5} + {Score}_{ObservableMeasure \#6} + {Score}_{ObservableMeasure \#7} + {Score}_{ObservableMeasure \#8} + {Score}_{ObservableMeasure \#9} + {Score}_{ObservableMeasure \#10} = Client \#1 Assessment {Score}_{BASELINE} ( 3 + 3 + 3 + 3 + 3 + 3 + 3 + 3 + 3 + 3 ) = 30 ( Assessment {Score}_{BASELINEClient \#1} ) & Client \#1 \\ Score Total Algorithm \\ {Score}_{ObservableMeasure \#1} + {Score}_{ObservableMeasure \#2} + {Score}_{ObservableMeasure \#3} + {Score}_{ObservableMeasure \#4} + {Score}_{ObservableMeasure \#5} + {Score}_{ObservableMeasure \#6} + {Score}_{ObservableMeasure \#7} + {Score}_{ObservableMeasure \#8} + {Score}_{ObservableMeasure \#9} + {Score}_{ObservableMeasure \#10} = Client \#2 Assessment {Score}_{BASELINE} ( 3 + 3 + 3 + 3 + 3 + 3 + 3 + 3 + 3 + 3 ) = 30 ( Assessment {Score}_{BASELINEClient \#2} ) & Client \#2\end{matrix}$$

(Client #1 Assessment Score_{BASELINE}+Client #2 Assessment Score_{BASELINE})/(#clients assessed) Average Scoring Algorithm

(30)+(30)=60/2=30

### 4. Score to Percentage Conversion Algorithm

Maximum Available Score_{BASELINE}/Results of Average Scoring Algorithm Maximum Available Score_{BASELINE}=Observable Measures_{TOTAL}×Maximum Available Score

(10×5)/(30);

50/30=60%

The specifics contained herein should not be construed as limitations as to the scope of the invention, but rather as an example of the preferred embodiment of the invention. Variations is possible. There are other software programs designed and targeted for use in the human services fields and service delivery systems that have various applications. The computer program could be written in many variations of existing languages. There are many ways in which a direct, secure and electronic linkage could be established for the software. There are different ways in which memory and data can be stored in a computer. There are many ways to transmit data so that it is protected and that confidential nature of the data is maintained as it is transmitted between entities. There are various ways in which data can be encrypted as preparation for electronic transfer. There are existing methods to collect, track and assess interventions applied in different human service delivery systems and to client's identified as a participant in any number of interventions. There are ways and methods to conduct statistical analysis related to human services professional and/or paraprofessional activities, duties and responsibilities.

At least one possible embodiment relates to a computer software that allows human services workers who directly interact with clients and apply interventions to the clients to enter scores based on a defined scoring standard and the observable measures observed by the human services worker that correspond to the interventions applied. These scores of the observable measures correspond to an outcome indicator of a specific outcome area. Human services workers using the software program will be able to create a file that contains each client's baseline scoring and subsequent scoring to measure the impact the intervention applied has on the client's ability to make positive changes and ameliorate the identified concerns that caused the need for intervention. Information available through the software program will be available to service provider level agencies, county human service agencies and state human service agencies. The software will be a platform that provides the ability of state, county and service provider agencies to identify the impact intervention have on individual and family clients through empirical data and provide aggregate measurements of the changes interventions have on the global outcome areas in all human services fields.

The components disclosed in the patents, patent applications, patent publications, and other documents disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications, patent publications, and other documents cited herein, and in the Declaration attached hereto, are hereby incorporated by reference as if set forth in their entirety herein except for the exceptions indicated herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, patent applications, patent publications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, patent applications, patent publications, and other documents either incorporated by reference or not incorporated by reference.

All of the references and documents cited in any of the patents, patent applications, patent publications, and other documents cited herein, except for the exceptions indicated herein, are hereby incorporated by reference as if set forth in their entirety herein except for the exceptions indicated herein. All of the patents, patent applications, patent publications, and other documents cited herein, referred to in the immediately preceding sentence, include all of the patents, patent applications, patent publications, and other documents cited anywhere in the present application.

Words relating to the opinions and judgments of the author of all patents, patent applications, patent publications, and other documents cited herein and not directly relating to the technical details of the description of the embodiments therein are not incorporated by reference.

The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned words in this sentence, when not used to describe technical features of one or more embodiments of the patents, patent applications, patent publications, and other documents, are not considered to be incorporated by reference herein for any of the patents, patent applications, patent publications, and other documents cited herein.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications, patent publications, and other documents cited herein may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

### AT LEAST PARTIAL NOMENCLATURE

101 Human Services Workers
102 Computer Software Program and its Applications
103 Preinstalled or Upload Data
104 Outcome Area Templates
105 Outcome Indicator(s)
106 Indicator Standard(s)
107 Observable Measure(s)
108 Defined Scoring Scale
109 Data
110 Direct Service Electronic Linkage
111 Storage Devices
112 Register
113 Graphical Depiction of Completed Assessment
114 State Human Service Agencies, County Human Service Agencies Private Human Service Provider Agencies Educational Institutions
201 Human Services Delivery System State Agency/Entity
202 Human Services Delivery System County Agency/Entity
203 Human Services Delivery System Service Provider Agency/Entity
401 Defined Scoring Scale
402 Scoring Scale of 1 to 5
403 Score Transformed into Percentage Score
501 Evidence of Responses to Intervention
502 Memory Device
601 Access to Entity Database
701 Purchases of Rights to Use Assessment of Aggregate Data for Observable
702 Measures Assessment of Aggregate Data for Outcome
703 Indicators & Outcome Areas Impact Score of Interventions Applied and
704 Funding Spent
705 Statistics
706 Demographic Data
707 Geographical Data
708 Developmental Issues & Knowledge
709 Professional Issues & Knowledge
710 Research
711 Aggregate Outcome Information
712 Consultation
713 Professional Discourse & Communication
714 Supervision, Practices and Regulations
715 Any Sort of Information Related to Human Services Profession, Activities, Practice and duties of Human Services Professionals and Para-Professionals
801 Portable File
802 Professional Information
803 Credentials
804 Trainings

What is claimed is:

1. A method of using an electronic and integrated interface for professionals and paraprofessionals in one or more human service delivery system, using a readable medium that exists within a computer that has executable instructions that when those instructions are accessed causes a computer to perform a method, said method comprising:
i. A computer software program and its applications that provides a direct, secure and electronic linkage between multiple users and computers that are associated with human services entities, organizations, agencies, individuals, businesses with one or more human services function;
ii. Of an interface that provides one or more human services professional and/or paraprofessional the ability to do data entry into preinstalled and/or uploaded outcome area(s) templates;
iii. Of an interface that provides one or more human services professional and/or paraprofessional the ability to do data entry into preinstalled and/or uploaded outcome indicators(s) templates;
iv. Of an interface that provides one or more human services professional and/or paraprofessional the ability to do data entry into preinstalled and/or uploaded indicator standard(s) templates;
v. Of an interface that provides one or more human services professional and/or paraprofessional the ability to do data entry into preinstalled and/or uploaded observable measures(s) templates;
vi. Of an interface that provides one or more human services professional and/or paraprofessional the ability to do data entry into preinstalled and/or uploaded defined scoring scale templates;
vii. Provides an interface for the user to create and store electronic files including said data entry in a storage device;
viii. Provides a user interface that electronically transmits electronic files to human services entities, organizations, agencies, individuals, businesses with one or more human services function;
ix. Provides an user interface that provides a graphical depiction of the data entered in by the human service professional and/or paraprofessional; and
x. Provide user interface that provides one or more human services professional and/or paraprofessional access to human services information, wherein the human services information comprises: client populations, geographical data, diagnostic and assessment criteria, evaluation and assessment practices and methods, statistics, professional discourse and research, possible legal data, medications, psychopharmacological information related to human services entities, organizations, agencies, individuals, businesses with one or more human services function.

2. The method of claim 1 further includes providing a user interface that electronically transmits data files containing professional credentials associated with one or more human services professional and/or paraprofessional.

3. The method of claim 1 in which humans services assessment data and scoring methods and methodologies for determining client baseline scores and subsequent change scores is preinstalled.

4. The method of claim 1 in which users of the computer software program will register professional information as required access via a registration process prior to entering data into the computer software program.

5. The method of claim 1 in which the software program will create graphical depiction in graph form of data entered for baseline scoring and subsequent scoring of client's response to human services interventions, both as individual data and as aggregate data.

6. The method of claim 1 in which the software program will collect and store all data indefinitely that is entered into the system by a properly registered and authorized user.

7. The method of claim 1 in which the software program will collect data related to one or more human services organization relevant to the fee rate charged for interventions, the type and duration of interventions provided, the identification of human services professionals and/or paraprofessionals accessing, using or otherwise engaged in the use of the software.

8. The method of claim 1 in which the software program will collect data related to one or more human services organization relevant the identification of clients utilizing the services of the human services professionals and/or paraprofessionals who is accessing, using or otherwise engaged in the use of the software.

9. A method for generating an outcome indicator of a patient's social and behavioral health in response to intervention, said method comprising the steps of:
a) gathering a first set of observable measures of a patient's social and behavioral health;
b) inputting the patient's first gathered observable measures into a computational device;
c) generating a baseline assessment, with the computational device, wherein the method of generating a baseline assessment comprises the steps of:
d) scoring each first observable measure by comparing the observable measure with an indicator standard; and
e) adding the score of each first observable measure;
f) reporting the baseline assessment, with the computational device;
g) selecting and applying an initial intervention in response to the reported baseline assessment;
h) gathering a second set observable measures of a patient's social and behavioral health in response to the applied intervention;
i) inputting the patient's second gathered observable measures into a computational device;
j) transforming the second gathered observable measures, with the computational device, into a percentage score, wherein transforming comprises the steps of:
k) scoring each gathered second observable measure by comparing the observable measure with an indicator standard;
l) adding the score of each gathered second observable measure; and
m) diving the sum of each gathered second observable measure by the baseline;
o) reporting the transformed gathered second observable measures, with the computational device;
p) aggregating the reported transformed gathered second observable measures, with the computational device;
q) assessing the aggregated gathered second observable measures;
r) continuing or modifying the initial intervention or selecting a new intervention, in response to assessed second observable measures;
s) periodically repeating steps h) through r).
